(19) United States
(12) Patent Application Publication
(10) Pub. No.: US 2025/0334793 A1
(43) Pub. Date: Oct. 30, 2025

(54) LIGHT SCANNING APPARATUS AND IMAGE FORMING APPARATUS

(71) Applicant: CANON KABUSHIKI KAISHA, Tokyo (JP)

(72) Inventor: Ryota SATO, Tochigi (JP)

(21) Appl. No.: 19/184,335

(22) Filed: Apr. 21, 2025

(30) Foreign Application Priority Data
Apr. 24, 2024 (JP) 2024-070396

(51) Int. Cl. G02B 26/12; G03G 15/04; G03G 15/043

(52) U.S. Cl. CPC G02B 26/124; G03G 15/0409; G03G 15/0435

(57) ABSTRACT

A light scanning apparatus according to the present embodiments includes a deflecting unit configured to deflect a first light flux from a first light source to scan a first scanned surface in a main scanning direction, and a first incident optical system which includes a first optical portion having a diffracting surface, and is configured to guide the first light flux from the first light source to a first deflecting surface of the deflecting unit, in which a condition of 1.00<|P_{dm}|/|Pᵣₘ|≤1.50 is satisfied, where Pᵣₘ and P_{dm} represent a refractive power and a diffractive power in a main scanning cross section of the first optical portion, respectively.

### BACKGROUND

### Technical Field

The present disclosure is related to a light scanning apparatus, and particularly, to a light scanning apparatus suitably used in an image forming apparatus such as a laser beam printer (LBP), a digital copying machine or a multi-function printer.

### Description of the Related Art

Conventionally, there is known a light scanning apparatus that suppresses a deterioration in optical performance due to an increase in temperature by providing a diffracting surface in addition to a refracting surface in an incident optical system.

Japanese Patent Application Laid-Open No. 2014-115364 discloses a light scanning apparatus in which a value of a ratio between a refractive power of a refracting surface and a diffractive power of a diffracting surface is defined in order to suppress a shift of an image plane due to an increase in temperature.

### SUMMARY

A light scanning apparatus according to the embodiments includes a deflecting unit configured to deflect a first light flux from a first light source to scan a first scanned surface in a main scanning direction, and a first incident optical system which includes a first optical portion having a diffracting surface, and is configured to guide the first light flux from the first light source to a first deflecting surface of the deflecting unit, in which a following condition is satisfied:

1.00<|P_{dm}|/|Pᵣₘ|≤1.50
where Pᵣₘ and P_{dm} represent a refractive power and a diffractive power in a main scanning cross section of the first optical portion, respectively.

Further features of the present disclosure will become apparent from the following description of exemplary embodiments with reference to the attached drawings.

### BRIEF DESCRIPTION OF THE DRAWINGS

FIG. 1A is a partial schematic developed view in a main scanning cross section of a light scanning apparatus according to a first embodiment of the present invention.

FIG. 1B is a partial schematic developed view in the main scanning cross section of the light scanning apparatus according to the first embodiment.

FIG. 2A is a partial schematic developed view in a sub-scanning cross section of the light scanning apparatus according to the first embodiment.

FIG. 2B is a partial schematic developed view in the sub-scanning cross section of the light scanning apparatus according to the first embodiment.

FIG. 3 is a partial schematic sub-scanning cross sectional view of the light scanning apparatus according to the first embodiment.

FIG. 4A is a partial schematic developed view in the main scanning cross section of the light scanning apparatus according to the first embodiment.

FIG. 4B is a partial schematic sub-scanning cross sectional view of the light scanning apparatus according to the first embodiment.

FIG. 5 is a partially enlarged schematic sub-scanning cross sectional view of the light scanning apparatus according to the first embodiment.

FIG. 6A is a graph showing an image height dependence of a variation amount of astigmatism in the light scanning apparatus according to the first embodiment.

FIG. 6B is a graph showing an image height dependence of a variation amount of astigmatism in the light scanning apparatus according to the first embodiment.

FIG. 7A is a partial schematic developed view in the main scanning cross section of a light scanning apparatus according to a second embodiment of the present invention.

FIG. 7B is a partial schematic developed view in the main scanning cross section of the light scanning apparatus according to the second embodiment.

FIG. 8A is a partial schematic developed view in the sub-scanning cross section of the light scanning apparatus according to the second embodiment.

FIG. 8B is a partial schematic developed view in the sub-scanning cross section of the light scanning apparatus according to the second embodiment.

FIG. 9 is a partial schematic sub-scanning cross sectional view of the light scanning apparatus according to the second embodiment.

FIG. 10A is a graph showing an image height dependence of a variation amount of astigmatism in the light scanning apparatus according to the second embodiment.

FIG. 10B is a graph showing an image height dependence of a variation amount of astigmatism in the light scanning apparatus according to the second embodiment.

FIG. 11A is a partial schematic developed view in the main scanning cross section of a light scanning apparatus according to a third embodiment of the present invention.

FIG. 11B is a partial schematic developed view in the main scanning cross section of the light scanning apparatus according to the third embodiment.

FIG. 12A is a partial schematic developed view in the sub-scanning cross section of the light scanning apparatus according to the third embodiment.

FIG. 12B is a partial schematic developed view in the sub-scanning cross section of the light scanning apparatus according to the third embodiment.

FIG. 13 is a partial schematic sub-scanning cross sectional view of the light scanning apparatus according to the third embodiment.

FIG. 14A is a graph showing an image height dependence of a variation amount of astigmatism in the light scanning apparatus according to the third embodiment.

FIG. 14B is a graph showing an image height dependence of a variation amount of astigmatism in the light scanning apparatus according to the third embodiment.

FIG. 15 is a sub-scanning cross sectional view of a main part of a color image forming apparatus according to the present embodiments.

### DESCRIPTION OF THE EMBODIMENTS

Hereinafter, a light scanning apparatus according to the present embodiments is described in detail with reference to the accompanying drawings. Note that the drawings described below may be drawn on a scale different from the actual scale in order to facilitate understanding of the present disclosure.

In the following description, a main scanning direction is a direction perpendicular to a rotation axis of a deflecting unit and an optical axis of an imaging optical system (a direction in which a light flux is deflected to scan by the deflecting unit), and a sub-scanning direction is a direction parallel to the rotation axis of the deflecting unit.

In addition, the main scanning cross section is a cross section perpendicular to the sub-scanning direction, and the sub-scanning cross section is a cross section perpendicular to the main scanning direction.

Hereinafter, a main scanning direction is defined as a Y direction, a sub-scanning direction is defined as a Z direction, and a direction perpendicular to the main scanning direction and the sub-scanning direction is defined as an X direction.

### First Embodiment

Conventionally, in a light scanning apparatus in which an incident optical system for guiding a light flux from a light source to a deflecting unit is formed only by a single optical element with both of a refractive power and a diffractive power in order to achieve cost reduction, various configurations for suppressing a deterioration in optical performance due to an increase in temperature have been proposed.

For example, a light scanning apparatus is known in which the optical performance of each of an incident optical system and an imaging optical system is adjusted in accordance with a wavelength determined on the basis of a wavelength immediately after the light source is turned on and a wavelength when the light source is stabilized, thereby suppressing a deterioration in optical performance due to an increase in temperature of the light source.

However, in the light scanning apparatus, a change in a shape of at least one optical element, which may occur due to an increase in the temperature of the light source, is not considered.

Therefore, in the light scanning apparatus, an increase in difference between a focus in the main scanning cross section and the focus in the sub-scanning cross section, namely in astigmatism is not sufficiently suppressed.

Further, for example, there is known a light scanning apparatus that defines a value of a ratio between a refractive power and a diffractive power of a single optical element forming an incident optical system in order to suppress a shift of an image plane due to a change in environmental temperature.

However, in the light scanning apparatus, a shift amount of the image plane in the main scanning cross section is reduced to be within 1 mm, whereas the shift amount of the image plane in the sub-scanning cross section is allowed to be within 4 mm, when a variation amount of temperature is within a range of +30° C.

Therefore, the increase in astigmatism is not sufficiently suppressed in the light scanning apparatus.

As described above, in the conventionally proposed light scanning apparatus with the configuration for suppressing the deterioration of the optical performance due to the increase in temperature, the increase of the astigmatism is not sufficiently suppressed.

Accordingly, an object of the present embodiment is to provide a light scanning apparatus in which an incident optical system is formed of only a single diffracting optical element, and which can suppress the increase in astigmatism even when the environmental temperature changes due to the increase in the temperature of a light source.

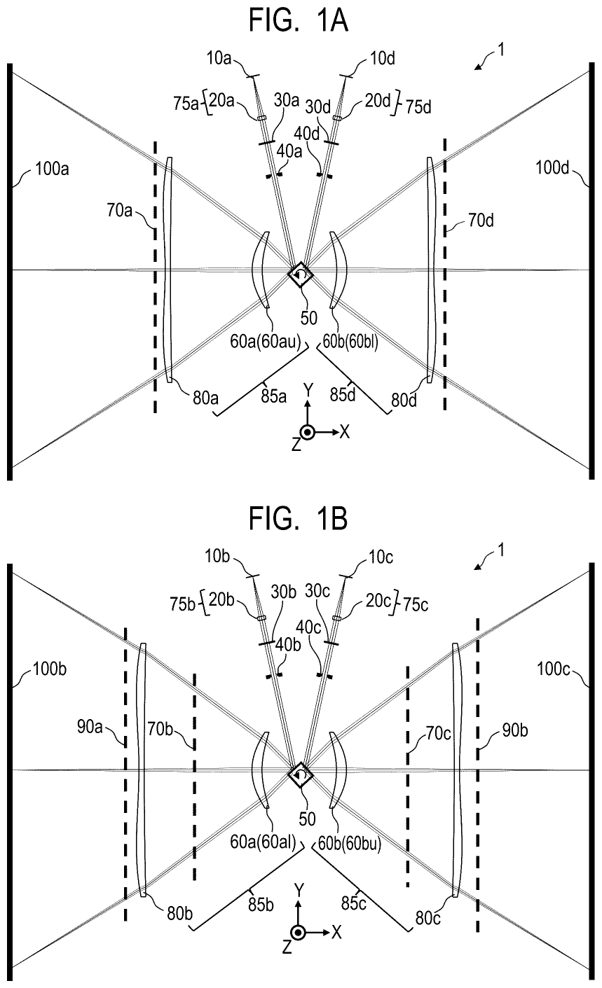

FIG. 1A and FIG. 1B show partial schematic developed views in the main scanning cross section of a light scanning apparatus 1 according to a first embodiment of the present invention.

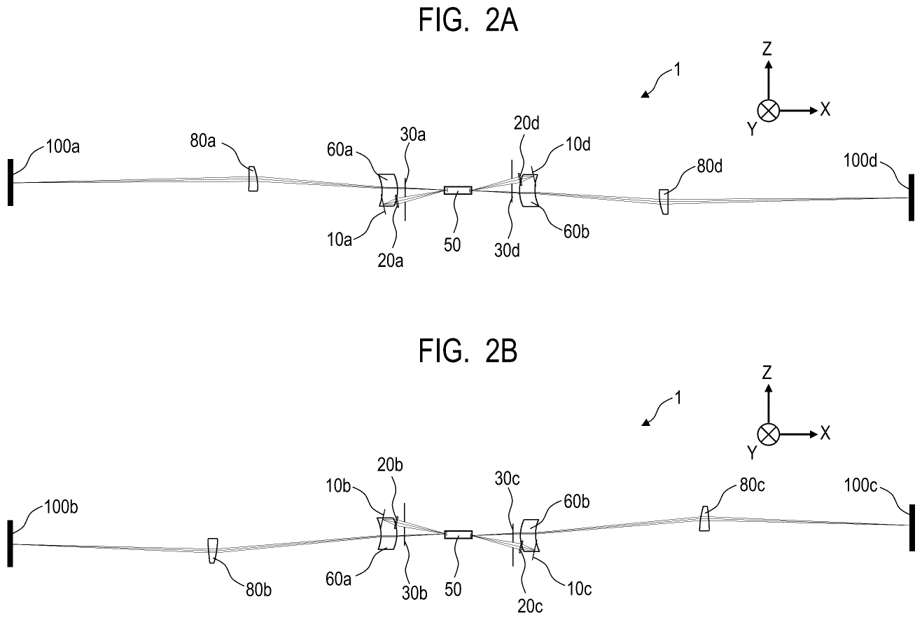

FIG. 2A and FIG. 2B show partial schematic developed views in the sub-scanning cross section of the light scanning apparatus 1 according to the first embodiment.

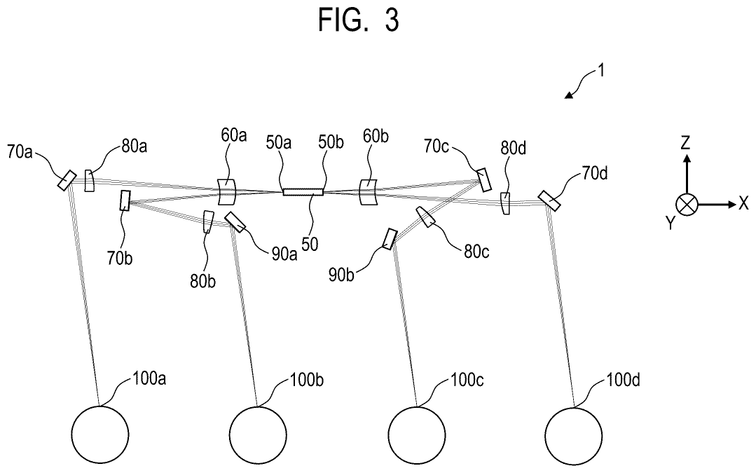

FIG. 3 shows a partial schematic sub-scanning cross sectional view of the light scanning apparatus 1 according to the first embodiment.

The light scanning apparatus 1 according to the present embodiment is configured to scan four scanned surfaces including a first scanned surface 100a, a second scanned surface 100b, a third scanned surface 100c, and a fourth scanned surface 100d, as described in detail later.

Of first and second photosensitive drums 100a and 100b corresponding to the first and second scanned surfaces 100a and 100b, respectively, the second photosensitive drum 100b is arranged closer to a deflecting unit 50 than the first photosensitive drum 100a in the X direction.

Of third and fourth photosensitive drums 100c and 100d corresponding to the third and fourth scanned surfaces 100c and 100d, respectively, the third photosensitive drum 100c is arranged closer to the deflecting unit 50 than the fourth photosensitive drum 100d in the X direction.

Specifically, FIG. 1A and FIG. 2A show a schematic developed view in the main scanning cross section and a schematic developed view in the sub-scanning cross section of a first incident optical system 75a and a first imaging optical system 85a which guide a first light flux to the first scanned surface 100a, respectively.

Further, FIG. 1A and FIG. 2A show a schematic developed view in the main scanning cross section and a schematic developed view in the sub-scanning cross section of a fourth incident optical system 75d and a fourth imaging optical system 85d which guide a fourth light flux to a fourth scanned surface 100d, respectively.

FIG. 1B and FIG. 2B show a schematic developed view in the main scanning cross section and a schematic developed view in the sub-scanning cross section of a second incident optical system 75b and a second imaging optical system 85b which guide a second light flux to the second scanned surface 100b, respectively.

Further, FIG. 1B and FIG. 2B show a schematic developed view in the main scanning cross section and a schematic developed view in the sub-scanning cross section of a third incident optical system 75c and a third imaging optical system 85c which guide a third light flux to the third scanned surface 100c, respectively.

In FIGS. 1A and 1B, reflecting optical elements 70a, 70b, 70c, 70d, 90a and 90b for reflecting the first to fourth light fluxes deflected by the deflecting unit 50 are indicated by broken lines, while the reflecting optical elements are not shown in FIGS. 2A and 2B.

The light scanning apparatus 1 according to the present embodiment includes first, second, third and fourth light sources 10a, 10b, 10c and 10d, and first, second, third and fourth optical elements 20a, 20b, 20c and 20d.

Further, the light scanning apparatus 1 according to the present embodiment includes first, second, third and fourth sub-scanning stops 30a, 30b, 30c and 30d, first, second, third and fourth main scanning stops 40a, 40b, 40c and 40d, and a deflecting unit 50.

Furthermore, the light scanning apparatus 1 according to the present embodiment includes first imaging optical elements 60a and 60b, second imaging optical elements 80a, 80b, 80c and 80d, and reflecting optical elements 70a, 70b, 70c, 70d, 90a and 90b.

In the light scanning apparatus 1 according to the present embodiment, the first incident optical system 75a which guides the first light flux from the first light source 10a to a first deflecting surface 50a of the deflecting unit 50 consists of the first optical element 20a.

The second incident optical system 75b which guides the second light flux from the second light source 10b to the first deflecting surface 50a of the deflecting unit 50 consists of the second optical element 20b.

The third incident optical system 75c which guides the third light flux from the third light source 10c to a second deflecting surface 50b of the deflecting unit 50 consists of the third optical element 20c.

The fourth incident optical system 75d which guides the fourth light flux from the fourth light source 10d to the second deflecting surface 50b of the deflecting unit 50 consists of the fourth optical element 20d.

That is, in the light scanning apparatus 1 according to the present embodiment, it is preferred that each of the first to fourth incident optical systems 75a to 75d consists of a single optical element.

Further, in the light scanning apparatus 1 according to the present embodiment, the first imaging optical system 85a is formed by an upper optical portion 60au of the first imaging optical element 60a and the second imaging optical element 80a.

The second imaging optical system 85b is formed by a lower optical portion 60al of the first imaging optical element 60a and the second imaging optical element 80b, and the third imaging optical system 85c is formed by an upper optical portion 60bu of the first imaging optical element 60b and the second imaging optical element 80c.

The fourth imaging optical system 85d is formed by a lower optical portion 60bl of the first imaging optical element 60b and the second imaging optical element 80d. Each of the first to fourth light sources 10a to 10d is formed by a semiconductor laser with a plurality of light emitting points.

Note that the number of light emitting points provided in each of the first to fourth light sources 10a to 10d may be one.

Further, the first and second light sources 10a and 10b are arranged at the same positions in the main scanning cross section, whereas are arranged at different positions in the sub-scanning direction.

Furthermore, the third and fourth light sources 10c and 10d are arranged at the same positions in the main scanning cross section, whereas are arranged at different positions in the sub-scanning direction.

The first to fourth optical elements 20a to 20d are anamorphic lenses with different powers between the main scanning cross section and the sub-scanning cross section.

The first to fourth optical elements 20a to 20d convert the first to fourth light fluxes emitted from the first to fourth light sources into parallel light fluxes in the main scanning cross section, respectively, and condense the first to fourth light fluxes in the sub-scanning cross section, respectively.

The parallel light flux includes not only a strictly parallel light flux but also a substantially parallel light flux such as a weakly divergent light flux or a weakly convergent light flux.

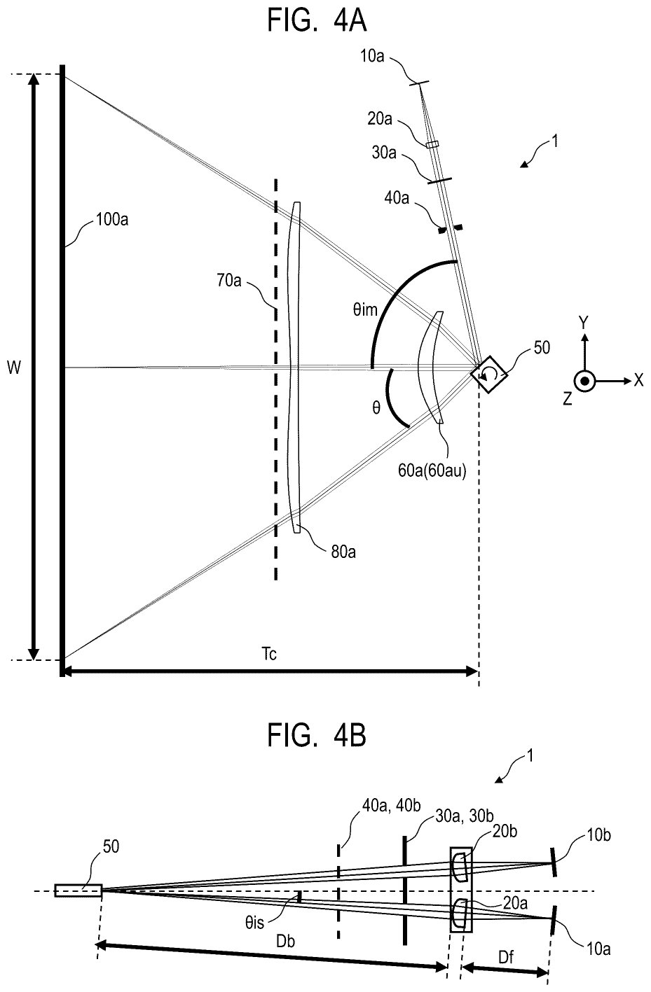

Further, in the light scanning apparatus 1 according to the present embodiment, the first and second optical elements 20a and 20b are formed integrally with each other (Refer to FIG. 4B), and the third and fourth optical elements 20c and 20d are formed integrally with each other.

That is, the first and second optical elements 20a and 20b form different optical portions (first and second optical portions) of a single (common) optical element.

Further, the third and fourth optical elements 20c and 20d form different optical portions (third and fourth optical portions) of a single (common) optical element.

The first to fourth sub-scanning stops 30a to 30d each have a rectangular opening, and regulate light flux widths in the sub-scanning direction of the first to fourth light fluxes that have passed through the first to fourth optical elements 20a to 20d, respectively.

That is, the first to fourth sub-scanning stops 30a to 30d are provided between the first to fourth optical elements 20a to 20d and the deflecting unit 50 in the first to fourth incident optical systems 75a to 75d, respectively.

In other words, the first to fourth sub-scanning stops 30a to 30d are provided on the downstream side of the first to fourth optical elements 20a to 20d in the first to fourth incident optical systems 75a to 75d, respectively.

The first to fourth main scanning stops 40a to 40d each have a rectangular opening, and regulate light flux widths in the main scanning direction of the first to fourth light fluxes that have passed through the first to fourth sub-scanning stops 30a to 30d, respectively.

The deflecting unit 50 is formed by a polygon mirror (rotary polygon mirror) with four reflecting surfaces, and is configured to be rotated at a constant speed in a direction of arrows in FIG. 1A and FIG. 1B by a driving unit (not shown) such as a motor.

Each of the first imaging optical elements 60a and 60b, and the second imaging optical elements 80a to 80d is formed by an fθ lens (scanning lens) having an fθ characteristic.

Each of the reflecting optical elements 70a, 70b, 70c, 70d, 90a and 90b is formed by a long mirror with no power for bending an optical path of a predetermined light flux in the sub-scanning direction by reflecting the predetermined light flux deflected by the deflecting unit 50.

As the first to fourth optical elements 20a to 20d, the first imaging optical elements 60a and 60b, and the second imaging optical elements 80a to 80d, plastic molded lenses formed by injection-molding a resin material are used.

However, the present invention is not limited thereto, and glass mold lenses may be used as them.

Since the molded lens is easy to form an aspherical shape and is suitable for mass production, productivity and optical performance can be improved by using the plastic molded lens as described above.

As the reflecting optical elements 70a, 70b, 70c, 70d, 90a and 90b, a general long glass on which a mirror surface is formed is used.

However, the present invention is not limited thereto, and a member which is formed by injection-molding a plastic material and on which a mirror surface is formed, or a member which is formed by a metal material such as aluminum and on which mirror finishing is performed may be used as each of them.

The reflecting surfaces of the reflecting optical elements 70a, 70b, 70c, 70d, 90a and 90b have a planar shape with no power, but may have a curved shape such as a spherical shape.

The first light flux emitted from the first light source 10a is converted into a parallel light flux in the main scanning cross section, and is condensed in the sub-scanning cross section by the first optical element 20a.

The first light flux having passed through the first optical element 20a is shaped by the first sub-scanning stop 30a and the first main scanning stop 40a, and is then condensed in the sub-scanning direction in the vicinity of the first deflecting surface 50a of the deflecting unit 50 to form a line image elongated in the main scanning direction.

The first incident optical system 75a causes the first light flux from the first light source 10a to be obliquely incident on the first deflecting surface 50a of the deflecting unit 50 in the sub-scanning cross section.

The first light flux deflected by the first deflecting surface 50a of the deflecting unit 50 is condensed by the upper optical portion 60au of the first imaging optical element 60a and the second imaging optical element 80a to form a spot on the first scanned surface 100a.

The first light flux deflected by the first deflecting surface 50a of the deflecting unit 50 is reflected by the reflecting optical element 70a in the sub-scanning direction when being guided to the first scanned surface 100a.

The second light flux emitted from the second light source 10b is converted into a parallel light flux in the main scanning cross section, and is condensed in the sub-scanning cross section by the second optical element 20b.

The second light flux having passed through the second optical element 20b is shaped by the second sub-scanning stop 30b and the second main scanning stop 40b, and is then condensed in the sub-scanning direction in the vicinity of the first deflecting surface 50a of the deflecting unit 50 to form a line image elongated in the main scanning direction.

The second incident optical system 75b causes the second light flux from the second light source 10b to be obliquely incident on the first deflecting surface 50a of the deflecting unit 50 in the sub-scanning cross section.

The second light flux deflected by the first deflecting surface 50a of the deflecting unit 50 is condensed by the lower optical portion 60al of the first imaging optical element 60a and the second imaging optical element 80b to form a spot on the second scanned surface 100b.

The second light flux deflected by the first deflecting surface 50a of the deflecting unit 50 is reflected in the sub-scanning direction by the reflecting optical elements 70b and 90a when being guided to the second scanned surface 100b.

Then, the first and second scanned surfaces 100a and 100b are scanned with the first and second light fluxes in the main scanning direction at a constant speed by rotating the deflecting unit 50 in the directions of the arrows in FIG. 1A and FIG. 1B.

Thereby, image recording can be performed on the first and second scanned surfaces 100a and 100b.

As shown in FIGS. 1A and 1B, the light scanning apparatus 1 according to the present embodiment employs a both-side scanning system that scans the first to fourth scanned surfaces 100a to 100d provided on both sides of the deflecting unit 50.

The third incident optical system 75c and the third imaging optical system 85c have configurations optically equivalent to those of the second incident optical system 75b and the second imaging optical system 85b, respectively.

The fourth incident optical system 75d and the fourth imaging optical system 85d have configurations optically equivalent to those of the first incident optical system 75a and the first imaging optical system 85a, respectively.

Therefore, the description of the configuration in which the third light flux is guided to the third scanned surface 100c by the third incident optical system 75c and the third imaging optical system 85c is omitted here.

Further, the description of the configuration in which the fourth light flux is guided to the fourth scanned surface 100d by the fourth incident optical system 75d and the fourth imaging optical system 85d is omitted.

Further, in the light scanning apparatus 1 according to the present embodiment, it is necessary to synchronize the timings at which the scanning is started with each other in order to align scanning lines formed on the first to fourth scanned surfaces 100a to 100d with each other.

Therefore, in the light scanning apparatus 1 according to the present embodiment, a part of the first light flux deflected by the first deflecting surface 50a of the deflecting unit 50 is made incident on a synchronization detection sensor (not shown).

Light emission timing of each of the first to fourth light sources 10a to 10d is determined using a BD signal acquired by the synchronization detection sensor.

Thereby, the formed scanning lines can be aligned with each other by synchronizing the timings of starting the scanning with each other on the first to fourth scanned surfaces 100a to 100d.

Next, Tables 1 and 2 below show specification values of the light scanning apparatus 1 according to the present embodiment, and the refractive index and coordinates of each optical surface, respectively.

Tables 3 and 4 below show the shapes of the optical surfaces in the first incident optical system 75a and the first imaging optical system 85a, and the shapes of the optical surfaces in the second incident optical system 75b and the second imaging optical system 85b, respectively.

In Table 2, only the first incident optical system 75a and the first imaging optical system 85a, and the second incident optical system 75b and the second imaging optical system 85b are shown.

TABLE 1

| | Parameters | |
|---|---|---|
| | [Units] | Value |
| Wavelength of first to fourth light sources 10a to 10d | λ[nm] | 790 |
| Scan widths of first to fourth scanned surfaces 100a to 100d | W[mm] | 326 |
| Number of deflecting surfaces of deflecting unit 50 | [surfaces] | 4 |
| Circumscribed diameter of deflecting unit 50 | Pd[mm] | 20 |
| Coordinates of rotation center of deflecting unit 50 | (X, Y)[mm] | (6.03, −3.79) |
| Incident angles in main scanning cross section of first to fourth incident | θim[rad] | 1.36 |
| optical systems 75a to 75d | | |
| Incident angles in sub-scanning cross section of first to fourth incident optical | θis[rad] | 0.05 |
| systems 75a to 75d | | |
| Widths in main scanning direction of openings of first to fourth main scanning | Am[mm] | 3.75 |
| stops 40a to 40d | | |
| Widths in sub-scanning direction of openings of first to fourth sub-scanning | As[mm] | 2.70 |
| stops 30a to 30d | | |
| Distances between first to fourth light sources 10a to 10d and first to fourth | Df[mm] | 33.59 |
| diffracting optical elements 20a to 20d | | |
| Distances between first to fourth diffracting optical elements 20a to 20d and | Db[mm] | 125.11 |
| first and second deflecting surfaces 50a and 50b | | |
| Total lengths of first to fourth imaging optical systems 85a to 85d | Tc[mm] | 233 |
| Maximum angles of view of first to fourth imaging optical systems 85a to 85d | θ[rad] | 0.79 |
| Combined magnification of first (fourth) incident optical system 75a (75d) and | βm_out | −6.55 |
| first (fourth) imaging optical system 85a (85d) in main scanning cross section | | |
| Combined magnification of first (fourth) incident optical system 75a (75d) and | βs_out | 5.30 |
| first (fourth) imaging optical system 85a (85d) in sub-scanning cross section | | |
| Combined magnification of second (third) incident optical system 75b (75c) | βm_in | −6.66 |
| and second (third) imaging optical system 85b (85c) in main scanning cross | | |
| section | | |
| Combined magnification of second (third) incident optical system 75b (75c) | βs_in | 5.30 |
| and second (third) imaging optical system 85b (85c) in sub-scanning cross | | |
| section | | |
| Refractive powers of first to fourth diffracting optical elements 20a to 20d in | Prm | 0.0142 |
| main scanning cross section | | |
| Diffractive powers of first to fourth diffracting optical elements 20a to 20d in | Pdm | 0.0157 |
| main scanning cross section | | |
| Refractive powers of first to fourth diffracting optical elements 20a to 20d in | Prs | 0.0202 |
| sub-scanning cross section | | |
| Diffractive powers of first to fourth diffracting optical elements 20a to 20d in | Pds | 0.0173 |
| sub-scanning cross section | | |

TABLE 2

| | Refractive | | | | Direction cosine of | | |
|---|---|---|---|---|---|---|---|
| | index (λ = | Coordinate of surface vertex | | | optical axis | | |
| | 790 nm) | tc(x) | tc(y) | tc(z) | gx(x) | gx(y) | gx(z) |
| Light emitting point of first light | — | −33.58 | 157.99 | −7.62 | −0.21 | 0.98 | −0.05 |
| source 10a | | | | | | | |
| Incident surface of first diffracting | 1.53 | −26.61 | 125.17 | −6.03 | −0.21 | 0.98 | −0.05 |
| optical element 20a | | | | | | | |
| Exit surface of first diffracting | — | −25.98 | 122.24 | −5.89 | −0.21 | 0.98 | −0.05 |
| optical element 20a | | | | | | | |
| First sub-scanning stop 30a | — | −22.01 | 103.53 | −4.99 | −0.21 | 0.98 | 0.00 |
| First main scanning stop 40a | — | −16.63 | 78.25 | −3.77 | −0.21 | 0.98 | 0.00 |
| First deflecting surface 50a of deflecting | — | 0.53 | 0.66 | 0.00 | −0.78 | 0.63 | 0.00 |
| unit 50 (when on-axis image height is scanned) | | | | | | | |
| Incident surface of first imaging optical | 1.53 | −26.00 | 0.00 | 0.00 | −1.00 | 0.00 | 0.00 |
| element 60a | | | | | | | |
| Exit surface of first imaging optical | — | −34.20 | 0.00 | 0.00 | −1.00 | 0.00 | 0.00 |
| element 60a | | | | | | | |
| Incident surface of second imaging optical | 1.53 | −100.80 | 0.00 | 5.96 | −1.00 | 0.00 | 0.00 |
| element 80a | | | | | | | |
| Exit surface of second imaging optical | — | −105.10 | 0.00 | 5.96 | −1.00 | 0.00 | 0.00 |
| element 80a | | | | | | | |
| Reflecting surface of reflecting optical | — | −113.67 | 0.00 | 5.58 | −0.76 | 0.00 | 0.65 |
| element 70a | | | | | | | |
| First scanned surface 100a | — | −97.70 | 0.00 | −112.69 | — | — | — |
| Light emitting point of second light source 10b | — | −33.58 | 157.99 | 7.62 | −0.21 | 0.98 | 0.05 |
| Incident surface of second diffracting optical | 1.53 | −26.61 | 125.17 | 6.03 | −0.21 | 0.98 | 0.05 |
| element 20b | | | | | | | |
| Exit surface of second diffracting optical | — | −25.98 | 122.24 | 5.89 | −0.21 | 0.98 | 0.05 |
| element 20b | | | | | | | |
| Second sub-scanning stop 30b | — | −22.01 | 103.53 | 4.99 | −0.21 | 0.98 | 0.00 |
| Second main scanning stop 40b | — | −16.63 | 78.25 | 3.77 | −0.21 | 0.98 | 0.00 |
| First deflecting surface 50a of deflecting unit 50 | — | 0.53 | 0.66 | 0.00 | −0.78 | 0.63 | 0.00 |
| (when on-axis image height is scanned) | | | | | | | |
| Incident surface of first imaging optical element | 1.53 | −26.00 | 0.00 | 0.00 | −1.00 | 0.00 | 0.00 |
| 60a | | | | | | | |
| Exit surface of first imaging optical element 60a | — | −34.20 | 0.00 | 0.00 | −1.00 | 0.00 | 0.00 |
| Incident surface of second imaging optical | 1.53 | −42.87 | 0.00 | −15.46 | −0.99 | 0.00 | 0.16 |
| element 80b | | | | | | | |
| Exit surface of second imaging optical element | — | −38.63 | 0.00 | −16.15 | −0.99 | 0.00 | 0.16 |
| 80b | | | | | | | |
| Reflecting surface of reflecting optical element | — | −81.82 | 0.00 | −4.68 | −1.00 | 0.00 | 0.08 |
| 70b | | | | | | | |
| Reflecting surface of reflecting optical element | — | −28.10 | 0.00 | −17.47 | −0.70 | 0.00 | −0.71 |
| 90a | | | | | | | |
| Second scanned surface 100b | — | −14.70 | 0.00 | −112.69 | — | — | — |

TABLE 3

| | Aspherical surface coefficient | | | | | | |
|---|---|---|---|---|---|---|---|
| | | | | Upper optical portion | | | |
| | | First diffracting optical | | 60au of first imaging | | Second imaging optical | |
| | | element 20a | | optical element 60a | | element 80a | |
| | | Incident | Exit | Incident | Exi | Incident | Exit |
| | Coefficient | surface | surface | surface | surface | surface | surface |
| Meridional | R | — | −3.72E+01 | −7.20E+01 | −4.32E+01 | −4.00E+03 | 3.46E+02 |
| line | K | — | — | 8.92E−01 | −5.73E−01 | — | −9.02E+01 |
| | B3 | — | — | — | — | — | — |
| | B4 | — | — | −7.61E−07 | −1.99E−07 | — | −2.17E−07 |
| | B5 | — | — | — | — | — | — |
| | B6 | — | — | 6.79E−09 | 1.64E−09 | — | 1.80E−11 |
| | B7 | — | — | — | — | — | — |
| | B8 | — | — | −5.89E−12 | 1.27E−12 | — | −1.07E−15 |
| | B9 | — | — | — | — | — | — |
| | B10 | — | — | 1.62E−15 | −1.42E−15 | — | 2.98E−20 |
| Sagittal | r | — | −2.62E+01 | 2.00E+01 | 2.06E+01 | 2.69E+01 | 2.94E+02 |
| line | E1 | — | — | — | — | — | 1.97E−07 |
| | E2 | — | — | — | 1.56E−05 | −5.14E−06 | −2.37E−06 |
| | E3 | — | — | — | — | — | −3.44E−09 |
| | E4 | — | — | — | −3.39E−08 | — | −2.47E−10 |
| | E5 | — | — | — | — | — | 1.50E−12 |
| | E6 | — | — | — | 3.96E−11 | — | 1.69E−14 |
| | E7 | — | — | — | — | — | −2.50E−16 |
| | E8 | — | — | — | −6.56E−14 | — | −1.80E−18 |
| | E9 | — | — | — | — | — | 1.41E−20 |
| | E10 | — | — | — | 5.40E−17 | — | 7.12E−23 |
| Additional | m0_1 | — | — | — | −3.93E−02 | −1.51E−01 | 1.07E−02 |
| terms | m1_1 | — | — | — | − | −5.64E−06 | 2.98E−06 |
| | m2_1 | — | — | — | 3.68E−05 | −2.60E−05 | −4.00E−05 |
| | m3_1 | — | — | — | — | 1.31E−07 | 1.17E−07 |
| | m4_1 | — | — | — | — | 5.69E−09 | 7.91E−09 |
| | m5_1 | — | — | — | — | −3.83E−11 | −3.15E−11 |
| | m6_1 | — | — | — | — | 8.34E−14 | −6.67E−13 |
| | m7_1 | — | — | — | — | 5.13E−15 | 3.85E−15 |
| | m8_1 | — | — | — | — | −2.89E−17 | 8.31E−17 |
| | m9_1 | — | — | — | — | −2.20E−19 | −1.37E−19 |
| | m10_1 | — | — | — | — | −5.52E−22 | −5.82E−21 |
| | C3(Z²) | −8.67E−03 | — | — | — | — | — |
| | C5(Y²) | −7.85E−03 | — | — | — | — | — |

TABLE 4

| | Aspherical surface coefficient | | | | | | |
|---|---|---|---|---|---|---|---|
| | | | | Lower optical portion | | | |
| | | Second incident optical | | 60al of first imaging | | Second imaging optical | |
| | | element 20b | | optical element 60a | | element 80b | |
| | | Incident | Exit | Incident | Exit | Incident | Exit |
| | Coefficient | surface | surface | surface | surface | surface | surface |
| Meridional | R | — | −3.72E+01 | −7.20E+01 | −4.43E+01 | −4.00E+03 | −3.84E+02 |
| line | K | — | — | 8.92E−01 | −1.16E+00 | — | −7.63E+01 |
| | B3 | — | — | — | — | — | — |
| | B4 | — | — | −7.61E−07 | −1.52E−06 | — | 1.34E−07 |
| | B5 | — | — | — | — | — | — |
| | B6 | — | — | 6.79E−09 | 1.75E−09 | — | −7.45E−12 |
| | B7 | — | — | — | — | — | — |
| | B8 | — | — | −5.89E−12 | 9.64E−13 | — | 3.30E−16 |
| | B9 | — | — | — | — | — | — |
| | B10 | — | — | 1.62E−15 | −1.20E−15 | — | −7.02E−21 |
| Sagittal | r | — | −2.62E+01 | 2.00E+01 | 5.46E+01 | −4.62E+01 | 1.10E+02 |
| line | E1 | — | — | — | — | — | 7.53E−07 |
| | E2 | — | — | — | 3.97E−06 | −5.27E−09 | −1.79E−06 |
| | E3 | — | — | — | — | — | 7.48E−10 |
| | E4 | — | — | — | 9.86E−08 | — | 2.81E−10 |
| | E5 | — | — | — | — | — | −1.82E−13 |
| | E6 | — | — | — | −2.89E−10 | — | −4.07E−14 |
| | E7 | — | — | — | — | — | 1.74E−17 |
| | E8 | — | — | — | 3.62E−13 | — | 3.25E−18 |
| | E9 | — | — | — | — | — | −5.09E−22 |
| | E10 | — | — | — | −1.62E−16 | — | −9.98E−23 |
| Additional | m0_1 | — | — | — | 1.14E−01 | −1.50E−01 | 7.95E−02 |
| terms | m1_1 | — | — | — | — | −2.04E−05 | −1.32E−05 |
| | m2_1 | — | — | — | −5.07E−05 | −3.51E−08 | −1.55E−05 |
| | m3_1 | — | — | — | — | 4.84E−08 | 4.46E−08 |
| | m4_1 | — | — | — | — | −5.23E−10 | 1.81E−09 |
| | m5_1 | — | — | — | — | −1.02E−11 | −8.81E−12 |
| | m6_1 | — | — | — | — | 2.07E−13 | −1.66E−13 |
| | m7_1 | — | — | — | — | 9.45E−16 | 7.76E−16 |
| | m8_1 | — | — | — | — | −2.87E−18 | 2.43E−17 |
| | m9_1 | — | — | — | — | −2.86E−20 | −2.11E−20 |
| | m10_1 | — | — | — | — | 7.60E−23 | −4.80E−22 |
| | C3(Z²) | −8.67E−03 | — | — | — | — | — |
| | C5(Y²) | −7.85E−03 | — | — | — | — | — |

FIG. 4A and FIG. 4B show a partial schematic developed view in the main scanning cross section and a partial schematic sub-scanning cross sectional view for explaining some of the parameters shown in Table 1 in the light scanning apparatus 1 according to the present embodiment, respectively.

In FIG. 4B, a broken line indicates a main scanning cross section including a center of the deflecting unit 50.

Incident surfaces of the first to fourth optical elements 20a to 20d provided in the light scanning apparatus 1 according to the present embodiment are formed as diffracting surfaces on which diffraction gratings are formed.

In the first to fourth optical elements 20a to 20d, the diffracting surfaces may be formed on exit surfaces instead of the incident surfaces, or the diffracting surfaces may be formed on both of the incident surfaces and the exit surfaces.

Specifically, the first to fourth optical elements 20a to 20d can be formed by injection-molding using a resin material, for example.

The light scanning apparatus 1 according to the present embodiment employs a so-called temperature compensation optical system in which a change in refractive power due to an environmental change is compensated for by a change in diffractive power due to a wavelength change of a semiconductor laser.

More specifically, the diffracting surface formed on each of the first to fourth optical elements 20a to 20d is defined by a phase function φ expressed by the following expression (1):

$$ϕ = \frac{2 π M}{λ} ( {C}_{3} {Z}^{2} \times {C}_{5} {Y}^{2} ) . \qquad ( 1 )$$

In the expression (1), M represents a diffractive coefficient, specifically, first order diffracted light is used in the light scanning apparatus 1 according to the present embodiment, namely Mis 1.

Further, λ represents a design wavelength, specifically, λ is 790 nm in the light scanning apparatus 1 according to the present embodiment.

A meridional line shape of each of incident surfaces and exit surfaces of the first imaging optical elements 60a and 60b and the second imaging optical elements 80a to 80d provided in the light scanning apparatus 1 according to the present embodiment has an aspherical shape represented by a polynomial function up to the tenth order.

Specifically, for each of the incident surfaces and the exit surfaces of the first imaging optical elements 60a and 60b and the second imaging optical elements 80a to 80d, an intersection point with an optical axis (namely, a surface vertex) is set as the origin, and a direction parallel to the optical axis is defined as an X-axis.

Further, an axis perpendicular to the optical axis in the main scanning cross section is defined as a Y-axis, and an axis perpendicular to the optical axis in the sub-scanning cross section is defined as a Z-axis.

At this time, the shape (meridional line shape) in the main scanning cross section of each of the incident surfaces and the exit surfaces of the first imaging optical elements 60a and 60b and the second imaging optical elements 80a to 80d is expressed by the following expression (2):

$$X = \frac{\frac{{Y}^{2}}{R}}{1 + \sqrt{1 - ( 1 + K ) {( \frac{Y}{R} )}^{2}}} + {\sum }_{i = 3}^{10} {B}_{i} {Y}^{i} . \qquad ( 2 )$$

In expression (2), R represents a curvature radius (curvature radius of meridional line) in the main scanning cross section, K represents an eccentricity, and B₃, B₄, B₅, B₆, B₇, B₈, B₉ and B₁₀ represent aspherical coefficients.

Further, the shape (sagittal line shape) of each of the incident surfaces and the exit surfaces of the first imaging optical elements 60a and 60b and the second imaging optical elements 80a to 80d in the sub-scanning cross section is expressed by the following expression (3):

$$S = \frac{\frac{{Z}^{2}}{{r}^{′}}}{1 + \sqrt{1 - {( \frac{Z}{{r}^{′}} )}^{2}}} + {\sum }_{i = 1}^{1} {\sum }_{j = 0}^{10} {m}_{j \_ i} {Y}^{j} {Z}^{i} . \qquad ( 3 )$$

In expression (3), S represents a sagittal shape defined in a cross section which includes a normal of the meridional line at each position on the meridional line and is perpendicular to the main scanning cross section, and m_{j_i} represents an aspheric coefficient.

In addition, r′ represents a curvature radius (curvature radius of sagittal line) in the sub-scanning cross section at a position away from the optical axis by Y in the main scanning direction, specifically, is expressed by the following expression (4):

$$\frac{1}{{r}^{′}} = \frac{1}{r} + {\sum }_{i = 1}^{10} {E}_{i} {Y}^{i} . \qquad ( 4 )$$

In the expression (4), r represents the curvature radius of the sagittal line on the optical axis, and E₁, E₂, E₃, E₄, E₅, E₆, E₇, E₈, E₉ and E₁₀ represent sagittal line variation coefficients.

In the light scanning apparatus 1 according to the present embodiment, the surface shapes of the incident surfaces and the exit surfaces of the first imaging optical elements 60a and 60b and the second imaging optical elements 80a to 80d are defined by functions expressed by the above-described expressions.

However, a scope of rights of the present invention is not limited by the above-described definitions.

As shown in FIG. 3, the first and second light fluxes deflected by the first deflecting surface 50a of the deflecting unit 50 pass through the common first imaging optical element 60a.

On the other hand, as shown in Table 3, the exit surface of the first imaging optical element 60a is defined by aspherical coefficients different from each other, namely has aspheric shapes different from each other in regions through which the first and second light fluxes pass.

In other words, the first imaging optical element 60a is an optical element in which an upper optical portion 60au and a lower optical portion 60al are formed integrally with each other such that the shape of the exit surface are different from each other between an upper side and a lower side in the sub-scanning direction.

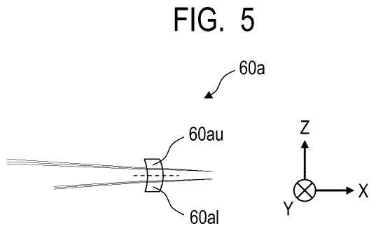

FIG. 5 shows a schematic sub-scanning cross sectional view of the first imaging optical element 60a provided in the light scanning apparatus 1 according to the present embodiment.

As shown in FIG. 5, the first imaging optical element 60a has the upper optical portion 60au provided on a side opposite to the scanned surface and the lower optical portion 60al provided on a side of the scanned surface with respect to a center line indicated by a broken line passing through the surface apexes of the incident surface and the exit surface in the sub-scanning cross section.

The upper optical portion 60au and the lower optical portion 60al are defined by the aspherical coefficients shown in Tables 3 and 4, respectively.

Thereby, the first and second light fluxes deflected by the first deflecting surface 50a of the deflecting unit 50 can be efficiently condensed on the first and second scanned surfaces 100a and 100b, respectively.

Next, an influence of an increase in temperature on an optical performance in the light scanning apparatus 1 according to the present embodiment is described.

When the semiconductor lasers used in the first to fourth light sources 10a to 10d are turned on, self-heating occurs and the temperature rises to change an environment temperature.

Then, the increase in temperature of the semiconductor lasers and the resultant change in the environmental temperature mainly generate the following three influences on the optical performance.

As a first influence, wavelengths of the semiconductor lasers forming the first to fourth light sources 10a to 10d, which are so-called mode hops, change.

In general, an oscillation wavelength of the semiconductor laser increases as the temperature rises. A variation amount in the oscillation wavelength per unit temperature becomes different according to a type and individual difference of the laser element used.

Specifically, as the first to fourth light sources 10a to 10d, it is possible to use the semiconductor laser whose wavelength λ changes by 0.26 nm when the temperature T changes by 1° C., namely, which has the variation amount of dλ/dT=0.26 (nm/° C.) as a general characteristic value.

As a second influence, a refractive index of an optical element arranged in the vicinity of the semiconductor laser changes due to an increase in the environmental temperature by an increase in the temperature of the semiconductor laser.

Specifically, in the light scanning apparatus 1 according to the present embodiment, the refractive indices of the first to fourth optical elements 20a to 20d arranged close to the first to fourth light sources 10a to 10d change.

In general, the refractive index of a resin material decreases when the temperature rises, whereas a variation amount in the refractive index per unit temperature becomes different according to a type and individual difference of the resin material used.

Specifically, the first to fourth optical elements 20a to 20d can be formed by a resin material whose refractive index n changes by −9.5×10⁻⁵ when the temperature T changes by 1° C., namely, which has the variation amount of dn/dT=−9.5×10⁻⁵ (/° C.) as a general characteristic value.

As a third influence, shapes of the first to fourth optical elements 20a to 20d arranged close to the first to fourth light sources 10a to 10b change due to an increase in the environmental temperature by an increase in temperature of the semiconductor laser.

In general, when the temperature rises, an optical element formed by a resin material expands, so that a power of an optical surface of the optical element decreases, whereas a thermal expansion coefficient per unit temperature of the optical element becomes different according to a type and individual difference of the resin material used.

Specifically, the first to fourth optical elements 20a to 20d can be formed by the resin material with the thermal expansion coefficient which isotropically expands by 0.008% when the temperature changes by 1° C. as a general characteristic value.

In the light scanning apparatus 1 according to the present embodiment, an increase in astigmatic aberration when the environmental temperature increases is suppressed by forming the first to fourth optical elements 20a to 20d in view of the above-described three influences.

Specifically, the light scanning apparatus 1 according to the present embodiment adopts a temperature compensation optical system using diffraction power.

More specifically, when the environmental temperature increases, the refractive indices of the first to fourth optical elements 20a to 20d decrease and the first to fourth optical elements 20a to 20d expand.

At this time, focuses by the first to fourth optical elements 20a to 20d are shifted so as to be further away from the first to fourth light sources 10a to 10d, respectively.

On the other hand, in the light scanning apparatus 1 according to the present embodiment, the oscillation wavelengths of the first to fourth light sources 10a to 10d become longer when the temperatures thereof increase.

At this time, the focuses by the first to fourth optical elements 20a to 20d are shifted so as to be closer to the first to fourth light sources 10a to 10d, respectively, according to the diffractive powers of the first to fourth optical elements 20a to 20d.

That is, in the light scanning apparatus 1 according to the present embodiment, the two shifts described above can cancel out each other by appropriately setting the diffractive power in each of the first to fourth optical elements 20a to 20d.

In fact, although a variation amount in the focus accompanied by changes in the refractive index and the shape described above also changes according to an arrangement of power, a share of the power in respective optical surfaces and the like in the entire light scanning apparatus 1 according to the present embodiment, it is generally proportional to a magnification of the entire system of the light scanning apparatus 1 according to the present embodiment.

Here, the entire system magnification of the light scanning apparatus 1 according to the present embodiment means a combined magnification of an incident optical system and an imaging optical system, in other words, a combined magnification (combined lateral magnification) of each optical element provided in each of the incident optical system and the imaging optical system.

Therefore, in the light scanning apparatus 1 according to the present embodiment, the diffractive power of each of the first to fourth optical elements 20a to 20d is set based on the entire system magnification.

Thereby, it is possible to effectively suppress the increase in astigmatism by adjusting the shift amount of the focus in each of the main scanning cross section and the sub-scanning cross section when the temperature of each of the first to fourth optical elements 20a to 20d increases.

Characteristics associated with the temperature increase of the laser diodes forming the first to fourth light sources 10a to 10d and the first to fourth optical elements 20a to 20d are not limited to those described above, and other characteristics may be considered.

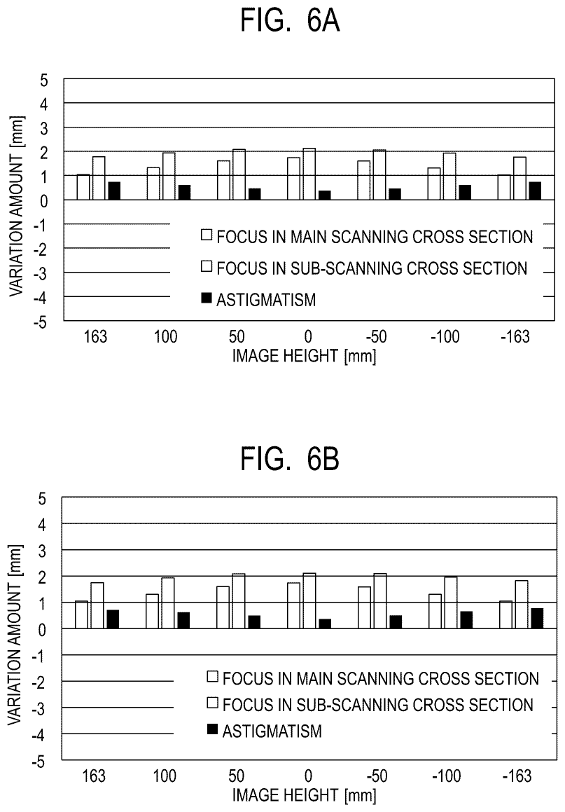

FIG. 6A shows an image height dependence of variation amounts in focus in the main scanning cross section, in focus in the sub-scanning cross section and in astigmatism on the first scanned surface 100a when the temperature increases by 25° C. in the light scanning apparatus 1 according to the present embodiment.

Further, FIG. 6B shows an image height dependence of variation amounts in focus in the main scanning cross section, in focus in the sub-scanning cross section and in astigmatism on the second scanned surface 100b when the temperature increases by 25° C. in the light scanning apparatus 1 according to the present embodiment.

Here, the astigmatism is calculated as a value obtained by subtracting the variation amount in focus in the main scanning cross section from that in the sub-scanning cross section.

Further, regarding a magnitude of the variation amount, a direction in which the focus moves away from the corresponding light source (rear side focus) is positive, and a direction in which the focus moves closer to the corresponding light source (front side focus) is negative.

Furthermore, a magnitude of the image height is positive on a side on which the first to fourth light sources 10a to 10d are arranged, whereas it is negative on a side opposite to the side on which the first to fourth light sources 10a to 10d are arranged with respect to the optical axes of the first to fourth imaging optical systems 85a to 85d.

In addition, a position of the focus is calculated from a position of a center of a region where a line spread function (LSF) width is equal to or smaller than a predetermined magnitude (slice level) when defocusing is performed in a direction parallel to the optical axis of the corresponding imaging optical system in the vicinity of the corresponding scanned surface.

The LSF width in the main scanning direction refers to a width when a light amount profile obtained by integrating a spot profile in the sub-scanning direction at each image height is sliced at a position of 13.5% with respect to the maximum value thereof.

Further, the LSF width in the sub-scanning direction refers to a width when a light amount profile obtained by integrating the spot profile in the main scanning direction at each image height is sliced at a position of 13.5% with respect to the maximum value thereof.

In the light scanning apparatus 1 according to the present embodiment, the slice level is set to 120 μm over the entire image heights in each of the main scanning direction and the sub-scanning direction.

As shown in FIG. 6A and FIG. 6B, in each of the first and second scanned surfaces 100a and 100b when the temperature increases by 25° C., the variation amount in the focus in the main scanning cross section and that in the sub-scanning cross section are comparable with each other.

When the temperature increases by 25° C., the variation amount in astigmatism is less than or equal to 1 mm over the entire image heights on each of the first and second scanned surfaces 100a and 100b, so that the increase in astigmatism can be effectively suppressed.

Next, each inequality in the light scanning apparatus 1 according to the present embodiment is described.

First, distances between light emitting surfaces of the first to fourth light sources 10a to 10d and incident surfaces of the first to fourth optical elements 20a to 20d on the optical axes of the first to fourth incident optical systems 75a to 75d are defined as D_{f}.

Here, the light emitting surfaces of the first to fourth light sources 10a to 10d are surfaces on which at least one light emitting point is arrayed in the first to fourth light sources 10a to 10d and which are perpendicular to the optical axes of the first to fourth incident optical systems 75a to 75d.

In other words, the light emitting surfaces of the first to fourth light sources 10a to 10d are planes which include at least one light emitting point in the first to fourth light sources 10a to 10d and which are perpendicular to the optical axes of the first to fourth incident optical systems 75a to 75d.

Further, distances between exit surfaces of the first and second optical elements 20a and 20b and an on-axis deflection point of the first deflecting surface 50a of the deflecting unit 50 on the optical axes of the first and second incident optical systems 75a and 75b are defined as D_{b}.

Similarly, distances between exit surfaces of the third and fourth optical elements 20c and 20d and an on-axis deflection point of the second deflecting surface 50b of the deflecting unit 50 on the optical axes of the third and fourth incident optical systems 75c and 75d are also defined as D_{b}.

Here, a light flux deflected by the deflecting unit 50 so as to scan an on-axis image height on a predetermined scanned surface is referred to as an on-axis light flux, and a deflection point of a principal ray of the on-axis light flux on a predetermined deflecting surface of the deflecting unit 50 is referred to as an on-axis deflection point.

Furthermore, absolute values of the refractive power and the diffractive power in the main scanning cross section of the first to fourth optical elements 20a to 20d are defined as |Pᵣₘ| and |P_{dm}|, respectively.

At this time, in the light scanning apparatus 1 according to the present embodiment, it is preferred that the following inequality (5) be satisfied, and the following inequality (6) is satisfied:

$$0.2 \leq \frac{{D}_{f}}{{D}_{b}} \leq 0.4 , \qquad ( 5 )$$

$$1. < \frac{\vert {P}_{dm} \vert}{\vert {P}_{rm} \vert} \leq 1.5 . \qquad ( 6 )$$

Here, the inequality (5) is a condition necessary for sufficiently suppressing an increase in astigmatism by satisfying the inequality (6) in the light scanning apparatus 1 according to the present embodiment.

If the ratio exceeds the upper limit value in the inequality (6), the cancellation by the diffraction power of the shift of the focus when the temperature increases in the main scanning cross section becomes too large, so that it becomes difficult to sufficiently suppress the increase in astigmatism, which is not preferable.

On the other hand, when the ratio is equal to or falls below the lower limit value in the inequality (6), the cancellation by the diffraction power of the shift of the focus when the temperature increases in the main scanning cross section becomes too small, so that it becomes difficult to sufficiently suppress the increase in astigmatism, which is not preferable.

In the light scanning apparatus 1 according to the present embodiment, it is preferred that the following inequality (6a) be satisfied instead of the inequality (6):

$$1. < \frac{\vert {P}_{d m} \vert}{\vert {P}_{r m} \vert} \leq 1 \text{.30} . \qquad ( 6 a )$$

Further, in the light scanning apparatus 1 according to the present embodiment, it is more preferred that the following inequality (6b) be satisfied instead of the inequality (6a):

$$1. < \frac{\vert {P}_{d m} \vert}{\vert {P}_{r m} \vert} \leq 1 \text{.20} . \qquad ( 6 b )$$

In the light scanning apparatus 1 according to the present embodiment, the inequality (5) is satisfied since Df/Db=33.59/125.11=0.268 is obtained in the first to fourth incident optical systems 75a to 75d from Table 1.

Further, the inequalities (6), (6a) and (6b) are satisfied since |P_{dm}|/|Pᵣₘ|=10.0157|/|0.0142|=1.106 is obtained in the first to fourth optical elements 20a to 20d from Table 1.

Next, absolute values of the magnification of the entire system in the main scanning cross section and the sub-scanning cross section of the light scanning apparatus 1 according to the present embodiment are defined as |βₘ| and |βₛ|, respectively.

At this time, in the light scanning apparatus 1 according to the present embodiment, it is preferred that the following inequality (7) be satisfied:

$$1. < \frac{\vert {β}_{m} \vert}{\vert {β}_{s} \vert} . \qquad ( 7 )$$

In other words, in the light scanning apparatus 1 according to the present embodiment, it is preferred that the absolute value of the magnification of the entire system in the main scanning cross section be larger than that in the sub-scanning cross section.

If the ratio is equal to or less than the lower limit value in the inequality (7), the shift amount of the focus in the sub-scanning cross section when the temperature increases becomes too large, so that it becomes difficult to sufficiently suppress an increase in astigmatism, which is not preferable.

In the light scanning apparatus 1 according to the present embodiment, it is more preferred that the following inequality (7a) be satisfied instead of the inequality (7):

$$1. < \frac{\vert {β}_{m} \vert}{\vert {β}_{s} \vert} \leq 1 \text{.40} . \qquad ( 7 a )$$

If the ratio exceeds the upper limit value in the inequality (7a), the shift amount of the focus in the main scanning cross section when the temperature increases becomes too large, so that it becomes difficult to sufficiently suppress the increase in astigmatism, which is not preferable.

Further, in the light scanning apparatus 1 according to the present embodiment, it is still more preferred that the following inequality (7b) be satisfied instead of the inequality (7a):

$$1.1 \leq \frac{\vert {β}_{m} \vert}{\vert {β}_{s} \vert} \leq 1.3 . \qquad ( 7 b )$$

In the light scanning apparatus 1 according to the present embodiment, |βₘ|/|βₛ|=|−6.55|/|5.30|=1.236 is obtained for the first and fourth scanned surfaces 100a and 100d from Table 1.

Further, |βₘ|/|βₛ|=|−6.66|/|5.30|=1.257 is obtained for the second and third scanned surfaces 100b and 100c.

Accordingly, in the light scanning apparatus 1 according to the present embodiment, the inequalities (7), (7a) and (7b) are satisfied for the first to fourth scanned surfaces 100a to 100d.

Next, absolute values of the refractive power and the diffractive power in the sub-scanning cross section of the first to fourth optical elements 20a to 20d provided in the light scanning apparatus 1 according to the present embodiment are defined as |Pᵣₛ| and |Pₐₛ|, respectively.

At this time, in the light scanning apparatus 1 according to the present embodiment, it is preferred that the following inequality (8) be satisfied:

$$\frac{\vert {P}_{d s} \vert}{\vert {P}_{r s} \vert} < 1 \text{.00} . \qquad ( 8 )$$

In other words, in the light scanning apparatus 1 according to the present embodiment, it is preferred that the absolute values of the refractive powers in the sub-scanning cross section be larger than the absolute values of the diffractive powers in the sub-scanning cross section in the first to fourth optical elements 20a to 20d.

If the ratio is equal to or larger than the upper limit value in the inequality (8), the cancellation by the diffraction power of the shift of the focus when the temperature increases in the sub-scanning cross section becomes too large, so that it becomes difficult to sufficiently suppress an increase in astigmatism, which is not preferable.

In the light scanning apparatus 1 according to the present embodiment, it is more preferred that the following inequality (8a) be satisfied instead of the inequality (8):

$$0.8 \leq \frac{\vert {P}_{d s} \vert}{\vert {P}_{r s} \vert} < 1 \text{.00} . \qquad ( 8 a )$$

If the ratio falls below the lower limit value in the inequality (8a), the cancellation by the diffraction power of the shift of the focus when the temperature increases in the sub-scanning cross section becomes too small, so that it becomes difficult to sufficiently suppress the increase in astigmatism, which is not preferable.

Further, in the light scanning apparatus 1 according to the present embodiment, it is still more preferred that the following inequality (8b) be satisfied instead of the inequality (8a):

$$0.8 \leq \frac{\vert {P}_{d s} \vert}{\vert {P}_{r s} \vert} \leq 0 \text{.95} . \qquad ( 8 b )$$

In the light scanning apparatus 1 according to the present embodiment, since |P_{ds}|/|Pᵣₛ|=|0.0173|/|0.0202|=0.856 is obtained in the first and fourth optical elements 20a and 20d from Table 1, the inequalities (8), (8a) and (8b) are satisfied.

Next, distances between the axial deflection point on the first deflecting surface 50a and the first and second scanned surfaces 100a and 100b on the optical axes of the first and second imaging optical systems 85a and 85b are defined as T_{c}.

Similarly, distances between the axial deflection point on the second deflecting surface 50b and the third and fourth scanned surfaces 100c and 100d on the optical axes of the third and fourth imaging optical systems 85c and 85d are also defined as T_{c}.

Further, an angle formed by traveling directions of the first and second light fluxes traveling toward the outermost off-axis image heights of the first and second scanned surfaces 100a and 100b when deflected by the first deflecting surface 50a in the main scanning cross section with respect to the optical axes of the first and second imaging optical systems 85a and 85b is defined as θ.

Similarly, angles formed by traveling directions of the third and fourth light fluxes traveling toward the outermost off-axis image heights of the third and fourth scanned surfaces 100c and 100d when deflected by the second deflecting surface 50b in the main scanning cross section with respect to the optical axes of the third and fourth imaging optical systems 85c and 85d are also defined as θ.

At this time, in the light scanning apparatus 1 according to the present embodiment, it is preferred that the following inequality (9) be satisfied:

$$200 \leq {T}_{c} \times tan θ \leq 300. \qquad ( 9 )$$

If the value exceeds the upper limit value in the inequality (9), the sizes of the first to fourth incident optical systems 75a to 75d become too large, so that the magnifications in the sub-scanning cross section of the first to fourth incident optical systems 75a to 75d, and the magnification of the entire system in the sub-scanning cross section increase, which is not preferable.

On the other hand, the value falls below the lower limit value in the inequality (9), the sizes of the first to fourth imaging optical systems 85a to 85d become too small, so that the sizes of the first to fourth incident optical systems 75a to 75d also become small, namely the total lengths of the first to fourth incident optical systems 75a to 75d become small. In this case, the first to fourth optical elements 20a to 20d may be affected by heat generated by the deflecting unit 50, which is not preferable.

In the light scanning apparatus 1 according to the present embodiment, it is more preferred that the following inequality (9a) be satisfied instead of the inequality (9):

$$200 \leq {T}_{c} \times tan θ \leq 250. \qquad ( 9 a )$$

In the light scanning apparatus 1 according to the present embodiment, since T_{c}×tan θ=233×tan (0.79)=235.154 is obtained in the first to fourth imaging optical systems 85a to 85d from Table 1, the inequalities (9) and (9a) are satisfied.

As described above, in the light scanning apparatus 1 according to the present embodiment, the first to fourth incident optical systems 75a to 75d that guide the first to fourth light fluxes from the first to fourth light sources 10a to 10d to the deflecting unit 50 consist of the first to fourth optical elements 20a to 20d having the diffracting surfaces, respectively.

When the inequalities (5) and (6) are satisfied in such incident optical systems, it is possible to sufficiently suppress an increase in astigmatism due to an increase in temperature in the light scanning apparatus 1 according to the present embodiment.

The above-described configuration can be similarly applied to a light scanning apparatus that scans a single scanned surface.

Further, the first and second optical elements 20a and 20b may be provided separately from each other, and the third and fourth optical elements 20c and 20d may be provided separately from each other.

### Second Embodiment

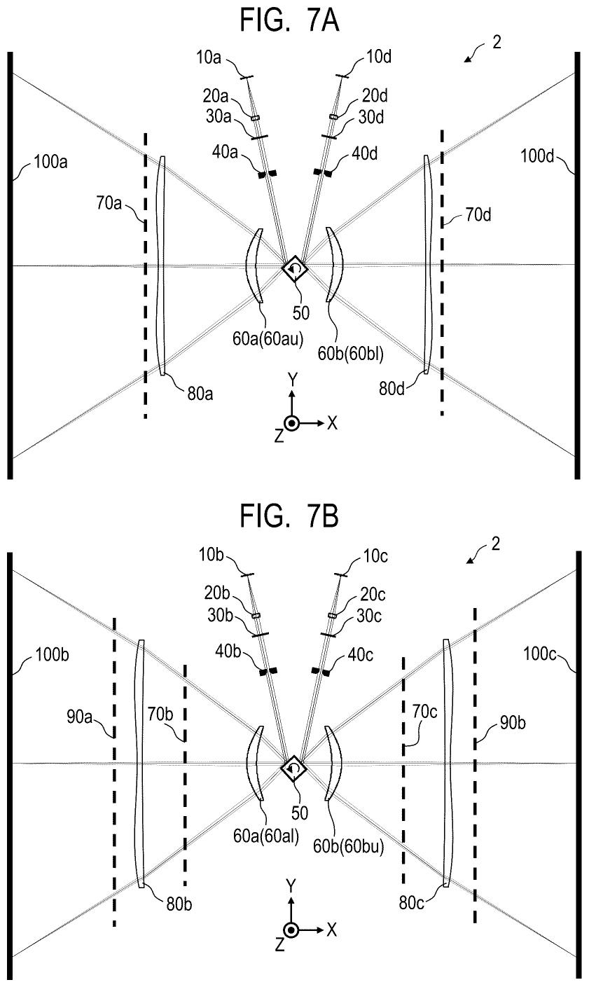

FIG. 7A and FIG. 7B show partial schematic developed views in a main scanning cross section of a light scanning apparatus 2 according to a second embodiment of the present invention.

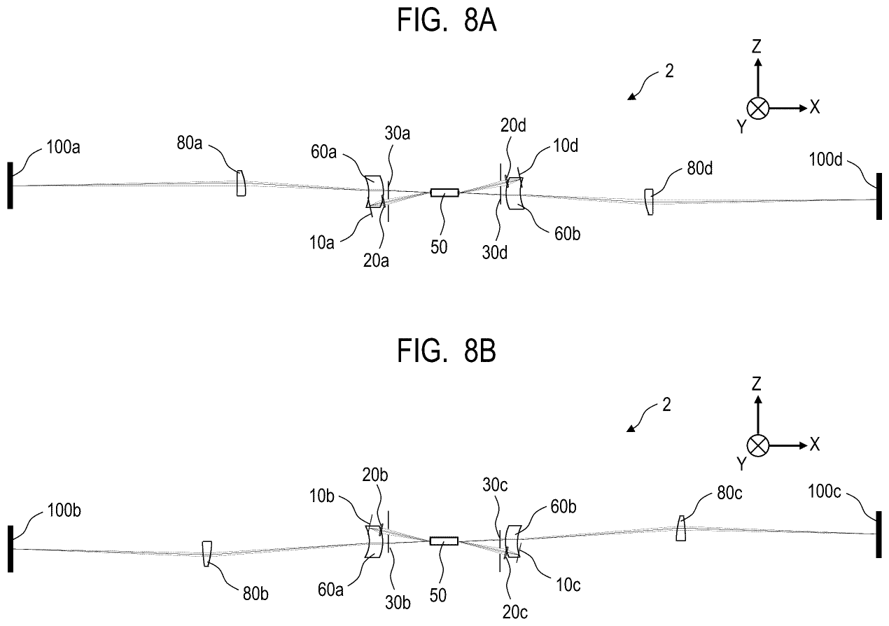

Further, FIG. 8A and FIG. 8B show partial schematic developed views in the sub-scanning cross section of the light scanning apparatus 2 according to the second embodiment.

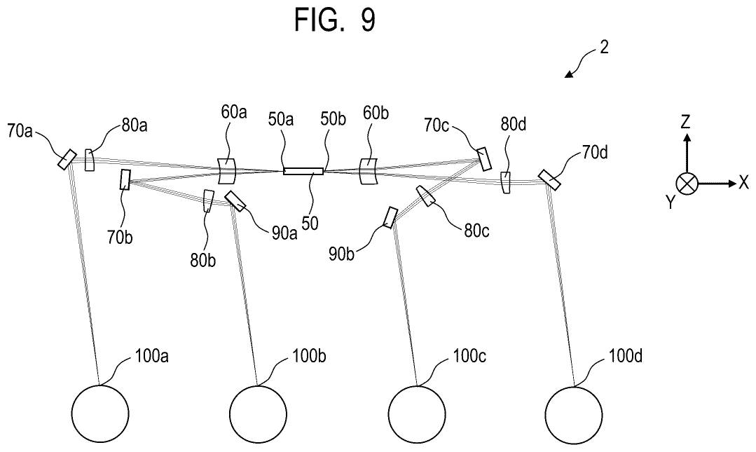

Furthermore, FIG. 9 shows a partial schematic sub-scanning cross sectional view of the light scanning apparatus 2 according to the second embodiment.

Since the light scanning apparatus 2 according to the present embodiment has the same configuration as that of the light scanning apparatus 1 according to the first embodiment except that numerical values are different, the same members are denoted by the same reference numerals, and description thereof is omitted.

Further, Tables 5 and 6 below show specification values, and the refractive index and coordinates of each optical surface in the light scanning apparatus 2 according to the present embodiment.

Furthermore, Tables 7 and 8 below show a shape of each optical surface in the first incident optical system 75a and the first imaging optical system 85a and a shape of each optical surface in the second incident optical system 75b and the second imaging optical system 85b, respectively.

In Table 6, only the first incident optical system 75a and the first imaging optical system 85a, and the second incident optical system 75b and the second imaging optical system 85b are shown.

TABLE 5

| | Parameters | |
|---|---|---|
| | [Units] | Value |
| Wavelength of first to fourth light sources 10a to 10d | λ[nm] | 790 |
| Scan widths of first to fourth scanned surfaces 100a to 100d | W[mm] | 326 |
| Number of deflecting surfaces of deflecting unit 50 | [surfaces] | 4 |
| Circumscribed diameter of deflecting unit 50 | Pd[mm] | 20 |
| Coordinates of rotation center of deflecting unit 50 | (X, Y)[mm] | (6.03, −3.79) |
| Incident angles in main scanning cross section of first to fourth incident | θim[rad] | 1.36 |
| optical systems 75a to 75d | | |
| Incident angles in sub-scanning cross section of first to fourth incident optical | θis[rad] | 0.05 |
| systems 75a to 75d | | |
| Widths in main scanning direction of openings of first to fourth main scanning | Am[mm] | 3.75 |
| stops 40a to 40d | | |
| Widths in sub-scanning direction of openings of first to fourth sub-scanning | As[mm] | 2.70 |
| stops 30a to 30d | | |
| Distances between first to fourth light sources 10a to 10d and first to fourth | Df[mm] | 33.59 |
| diffracting optical elements 20a to 20d | | |
| Distances between first to fourth diffracting optical elements 20a to 20d and | Db[mm] | 125.11 |
| first and second deflecting surfaces 50a and 50b | | |
| Total lengths of first to fourth imaging optical systems 85a to 85d | Tc[mm] | 233 |
| Maximum angles of view of first to fourth imaging optical systems 85a to 85d | θ[rad] | 0.79 |
| Combined magnification of first (fourth) incident optical system 75a (75d) and | βm_out | −6.50 |
| first (fourth) imaging optical system 85a (85d) in main scanning cross section | | |
| Combined magnification of first (fourth) incident optical system 75a (75d) and | βs_out | 5.34 |
| first (fourth) imaging optical system 85a (85d) in sub-scanning cross section | | |
| Combined magnification of second (third) incident optical system 75b (75c) | βm_in | −6.56 |
| and second (third) imaging optical system 85b (85c) in main scanning cross | | |
| section | | |
| Combined magnification of second (third) incident optical system 75b (75c) | βs_in | 5.30 |
| and second (third) imaging optical system 85b (85c) in sub-scanning cross | | |
| section | | |
| Refractive powers of first to fourth diffracting optical elements 20a to 20d in | Prm | 0.0145 |
| main scanning cross section | | |
| Diffractive powers of first to fourth diffracting optical elements 20a to 20d in | Pdm | 0.0154 |
| main scanning cross section | | |
| Refractive powers of first to fourth diffracting optical elements 20a to 20d in | Prs | 0.0202 |
| sub-scanning cross section | | |
| Diffractive powers of first to fourth diffracting optical elements 20a to 20d in | Pds | 0.0173 |
| sub-scanning cross section | | |

TABLE 6

| | Refractive | | | | Direction cosine of | | |
|---|---|---|---|---|---|---|---|
| | index (λ = | Coordinate of surface vertex | | | optical axis | | |
| | 790 nm) | tc(x) | tc(y) | tc(z) | gx(x) | gx(y) | gx(z) |
| Light emitting point of first light source 10a | — | −33.58 | 157.99 | −7.62 | −0.21 | 0.98 | −0.05 |
| Incident surface of first diffracting optical | 1.53 | −26.61 | 125.17 | −6.03 | −0.21 | 0.98 | −0.05 |
| element 20a | | | | | | | |
| Exit surface of first diffracting optical | — | −25.98 | 122.24 | −5.89 | −0.21 | 0.98 | −0.05 |
| element 20a | | | | | | | |
| First sub-scanning stop 30a | — | −22.84 | 107.44 | −5.18 | −0.21 | 0.98 | 0.00 |
| First main scanning stop 40a | — | −16.63 | 78.25 | −3.77 | −0.21 | 0.98 | 0.00 |
| First deflecting surface 50a of deflecting unit | — | 0.53 | 0.66 | 0.00 | −0.78 | 0.63 | 0.00 |
| 50 (when on-axis image height is scanned) | | | | | | | |
| Incident surface of first imaging optical | 1.53 | −26.00 | 0.00 | 0.00 | −1.00 | 0.00 | 0.00 |
| element 60a | | | | | | | |
| Exit surface of first imaging optical element 60a | — | −34.20 | 0.00 | 0.00 | −1.00 | 0.00 | 0.00 |
| Incident surface of second imaging optical | 1.53 | −103.50 | 0.00 | 5.03 | −1.00 | 0.00 | 0.00 |
| element 80a | | | | | | | |
| Exit surface of second imaging optical element | — | −107.80 | 0.00 | 5.03 | −1.00 | 0.00 | 0.00 |
| 80a | | | | | | | |
| Reflecting surface of reflecting optical element | — | −114.19 | 0.00 | 4.98 | −0.76 | 0.00 | 0.65 |
| 70a | | | | | | | |
| First scanned surface 100a | — | −97.70 | 0.00 | −112.69 | — | — | — |
| Light emitting point of second light source 10b | — | −33.58 | 157.99 | 7.62 | −0.21 | 0.98 | 0.05 |
| Incident surface of second diffracting optical | 1.53 | −26.61 | 125.17 | 6.03 | −0.21 | 0.98 | 0.05 |
| element 20b | | | | | | | |
| Exit surface of second diffracting optical | — | −25.98 | 122.24 | 5.89 | −0.21 | 0.98 | 0.05 |
| element 20b | | | | | | | |
| Second sub-scanning stop 30b | — | −22.84 | 107.44 | 5.18 | −0.21 | 0.98 | 0.00 |
| Second main scanning stop 40b | — | −16.63 | 78.25 | 3.77 | −0.21 | 0.98 | 0.00 |
| First deflecting surface 50a of deflecting unit 50 | — | 0.53 | 0.66 | 0.00 | −0.78 | 0.63 | 0.00 |
| (when on-axis image height is scanned) | | | | | | | |
| Incident surface of first imaging optical element | 1.53 | −26.00 | 0.00 | 0.00 | −1.00 | 0.00 | 0.00 |
| 60a | | | | | | | |
| Exit surface of first imaging optical element 60a | — | −34.20 | 0.00 | 0.00 | −1.00 | 0.00 | 0.00 |
| Incident surface of second imaging optical | 1.53 | −46.37 | 0.00 | −17.30 | −0.97 | 0.00 | 0.26 |
| element 80b | | | | | | | |
| Exit surface of second imaging optical element | — | −42.22 | 0.00 | −18.43 | −0.97 | 0.00 | 0.26 |
| 80b | | | | | | | |
| Reflecting surface of reflecting optical element | — | −83.25 | 0.00 | −5.28 | −0.99 | 0.00 | 0.13 |
| 70b | | | | | | | |
| Reflecting surface of reflecting optical element | — | −27.55 | 0.00 | −21.93 | −0.74 | 0.00 | −0.67 |
| 90a | | | | | | | |
| Second scanned surface 100b | — | −14.70 | 0.00 | −112.69 | — | — | — |

TABLE 7

| | Aspherical surface coefficient | | | | | | |
|---|---|---|---|---|---|---|---|
| | | | | Upper optical portion | | | |
| | | First diffracting optical | | 60au of first imaging | | Second imaging optical | |
| | | element 20a | | optical element 60a | | element 80a | |
| | | Incident | Exit | Incident | Exit | Incident | Exit |
| | Coefficient | surface | surface | surface | surface | surface | surface |
| Meridional | R | — | −3.65E+01 | −7.11E+01 | −4.29E+01 | −4.00E+03 | 3.50E+02 |
| line | K | — | — | 9.46E−01 | −5.15E−01 | — | −8.75E+01 |
| | B3 | — | — | — | — | — | — |
| | B4 | — | — | −9.15E−07 | −3.48E−07 | — | −2.02E−07 |
| | B5 | — | — | — | — | — | — |
| | B6 | — | — | 6.78E−09 | 1.69E−09 | — | 1.61E−11 |
| | B7 | — | — | — | — | — | — |
| | B8 | — | — | −5.77E−12 | 1.11E−12 | — | −9.31E−16 |
| | B9 | — | — | — | — | — | — |
| | B10 | — | — | 1.64E−15 | −1.22E−15 | — | 2.52E−20 |
| Sagittal | r | — | −2.62E+01 | 2.00E+01 | 2.50E+01 | 3.71E+01 | −1.54E+02 |
| line | E1 | — | — | — | — | — | −1.28E−07 |
| | E2 | — | — | — | 1.52E−05 | −7.46E−07 | 1.81E−06 |
| | E3 | — | — | — | — | — | −3.24E−09 |
| | E4 | — | — | — | 8.49E−10 | — | −3.04E−10 |
| | E5 | — | — | — | — | — | 1.34E−12 |
| | E6 | — | — | — | −2.51E−11 | — | 3.08E−14 |
| | E7 | — | — | — | — | — | −2.01E−16 |
| | E8 | — | — | — | 7.61E−15 | — | −1.95E−18 |
| | E9 | — | — | — | — | — | 9.86E−21 |
| | E10 | — | — | — | 1.61E−17 | — | 5.81E−23 |
| Additional | m0_1 | — | — | — | −2.12E−02 | −1.01E−01 | 2.32E−02 |
| terms | m1_1 | — | — | — | — | −2.13E−04 | −2.00E−04 |
| | m2_1 | — | — | — | 3.32E−05 | −1.31E−05 | −2.37E−05 |
| | m3_1 | — | — | — | — | 1.16E−07 | 1.06E−07 |
| | m4_1 | — | — | — | — | 1.77E−09 | 3.67E−09 |
| | m5_1 | — | — | — | — | −1.62E−11 | −1.41E−11 |
| | m6_1 | — | — | — | — | 3.01E−13 | −3.05E−13 |
| | m7_1 | — | — | — | — | 1.06E−15 | 9.73E−16 |
| | m8_1 | — | — | — | — | −1.31E−17 | 6.57E−17 |
| | m9_1 | — | — | — | — | −1.66E−20 | −1.73E−20 |
| | m10_1 | — | — | — | — | −8.54E−22 | −3.96E−21 |
| | C3(Z²) | −8.67E−03 | — | — | — | — | — |
| | C5(Y²) | −7.70E−03 | — | — | — | — | — |

TABLE 8

| | Aspherical surface coefficient | | | | | | |
|---|---|---|---|---|---|---|---|
| | | | | Lower optical portion | | | |
| | | Second incident optical | | 60al of first imaging | | Second imaging optical | |
| | | element 20b | | optical element 60a | | element 80b | |
| | | Incident | Exit | Incident | Exit | Incident | Exit |
| | Coefficient | surface | surface | surface | surface | surface | surface |
| Meridional | R | — | −3.65E+01 | −7.11E+01 | −4.38E+01 | 4.00E+03 | −3.80E+02 |
| line | K | — | — | 9.46E−01 | −9.32E−01 | — | −7.41E+01 |
| | B3 | — | — | — | — | — | — |
| | B4 | — | — | −9.15E−07 | −1.35E−06 | — | 1.33E−07 |
| | B5 | — | — | — | — | — | — |
| | B6 | — | — | 6.78E−09 | 1.72E−09 | — | −7.21E−12 |
| | B7 | — | — | — | — | — | — |
| | B8 | — | — | −5.77E−12 | 8.76E−13 | — | 3.07E−16 |
| | B9 | — | — | — | — | — | — |
| | B10 | — | — | 1.64E−15 | −1.07E−15 | — | −6.09E−21 |
| Sagittal | r | — | −2.62E+01 | 2.00E+01 | 5.53E+01 | −3.74E+01 | 2.50E+02 |
| line | E1 | — | — | — | — | — | −9.41E−09 |
| | E2 | — | — | — | 6.89E−06 | 3.48E−07 | −1.45E−06 |
| | E3 | — | — | — | − | — | 1.62E−09 |
| | E4 | — | — | — | 8.42E−08 | — | 2.79E−10 |
| | E5 | — | — | — | − | — | −4.72E−13 |
| | E6 | — | — | — | −2.68E−10 | — | −4.45E−14 |
| | E7 | — | — | — | — | — | 5.35E−17 |
| | E8 | — | — | — | 3.44E−13 | — | 3.94E−18 |
| | E9 | — | — | — | — | — | −2.03E−21 |
| | E10 | — | — | — | −1.54E−16 | — | −1.36E−22 |
| Additional | m0_1 | — | — | — | 7.66E−02 | −1.21E−01 | 5.80E−02 |
| terms | m1_1 | — | — | — | — | −2.13E−04 | −2.00E−04 |
| | m2_1 | — | — | — | −3.91E−05 | −1.11E−05 | −2.29E−05 |
| | m3_1 | — | — | — | — | 1.42E−07 | 1.29E−07 |
| | m4_1 | — | — | — | — | 5.56E−10 | 2.63E−09 |
| | m5_1 | — | — | — | — | −2.59E−11 | −2.17E−11 |
| | m6_1 | — | — | — | — | 2.46E−13 | −2.07E−13 |
| | m7_1 | — | — | — | — | 2.15E−15 | 1.68E−15 |
| | m8_1 | — | — | — | — | −1.18E−17 | 3.21E−17 |
| | m9_1 | — | — | — | — | −6.13E−20 | −4.20E−20 |
| | m10_1 | — | — | — | — | −9.72E−23 | −1.49E−21 |
| | C3(Z²) | −8.67E−03 | — | — | — | — | — |
| | C5(Y²) | −7.70E−03 | — | — | — | — | — |

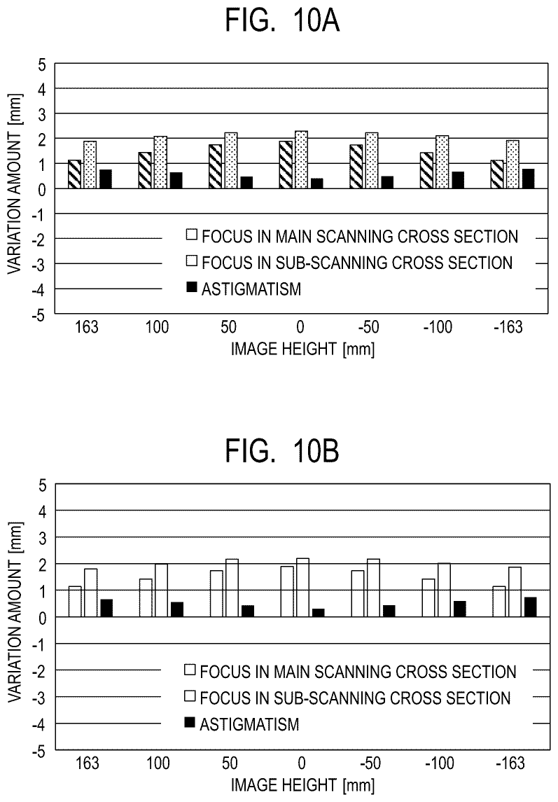

FIG. 10A shows an image height dependence of variation amounts in the focus in the main scanning cross section, in the focus in the sub-scanning cross section and in astigmatism on the first scanned surface 100a when the temperature increases by 25° C. in the light scanning apparatus 2 according to the present embodiment.

Further, FIG. 10B shows an image height dependence of variation amounts in the focus in the main scanning cross section, in the focus in the sub-scanning cross section and in astigmatism on the second scanned surface 100b when the temperature increases by 25° C. in the light scanning apparatus 2 according to the present embodiment.

As shown in FIG. 10A and FIG. 10B, in each of the first and second scanned surfaces 100a and 100b when the temperature increases by 25° C., the variation amount in the focus in the main scanning cross section and that in the sub-scanning cross section are comparable with each other.

When the temperature increases by 25° C., the variation amount in astigmatism is less than or equal to 1 mm over the entire image heights on each of the first and second scanned surfaces 100a and 100b, so that the increase in astigmatism can be effectively suppressed.

In the light scanning apparatus 2 according to the present embodiment, since D_{f}/D_{b}=33.59/125.11=0.268 is obtained in the first to fourth incident optical systems 75a to 75d from Table 5, the inequality (5) is satisfied.

In the light scanning apparatus 2 according to the present embodiment, since |P_{dm}|/|Pᵣₘ|=|0.0154|/|0.0145|=1.062 is obtained in the first to fourth optical elements 20a to 20d from Table 5, the inequalities (6), (6a) and (6b) are satisfied.

In the light scanning apparatus 2 according to the present embodiment, |βₘ|/|βₛ|=|−6.50|/|5.34|=1.217 is obtained for the first and fourth scanned surfaces 100a and 100d from Table 5.

For the second and third scanned surfaces 100b and 100c, |βₘ|/|βₛ|=|−6.56|/|5.30|=1.238 is obtained.

Therefore, in the light scanning apparatus 2 according to the present embodiment, the inequalities (7), (7a) and (7b) are satisfied for the first to fourth scanned surfaces 100a to 100d.

In the light scanning apparatus 2 according to the present embodiment, since |P_{ds}|/|Pᵣₛ|=|0.0173|/|0.0202|=0.856 is obtained in the first to fourth optical elements 20a to 20d from Table 5, the inequalities (8), (8a) and (8b) are satisfied.

In the light scanning apparatus 2 according to the present embodiment, since T_{c}×tan θ=233×tan (0.79)=235.154 is obtained in the first to fourth imaging optical systems 85a to 85d from Table 5, the inequalities (9) and (9a) are satisfied.

As described above, in the light scanning apparatus 2 according to the present embodiment, the first to fourth incident optical systems 75a to 75d that guide the first to fourth light fluxes from the first to fourth light sources 10a to 10d to the deflecting unit 50 consist of the first to fourth optical elements 20a to 20d having the diffracting surfaces, respectively.

When the inequalities (5) and (6) are satisfied in such incident optical systems, it is possible to sufficiently suppress an increase in astigmatism due to an increase in temperature in the light scanning apparatus 2 according to the present embodiment.

### Third Embodiment

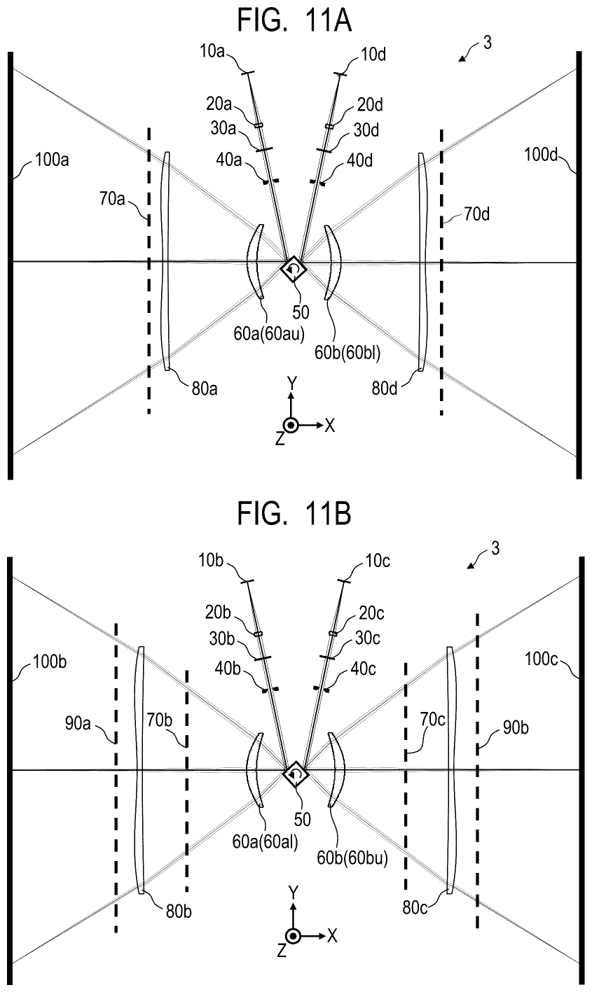

FIG. 11A and FIG. 11B show partial schematic developed views in a main scanning cross section of a light scanning apparatus 3 according to a third embodiment of the present invention.

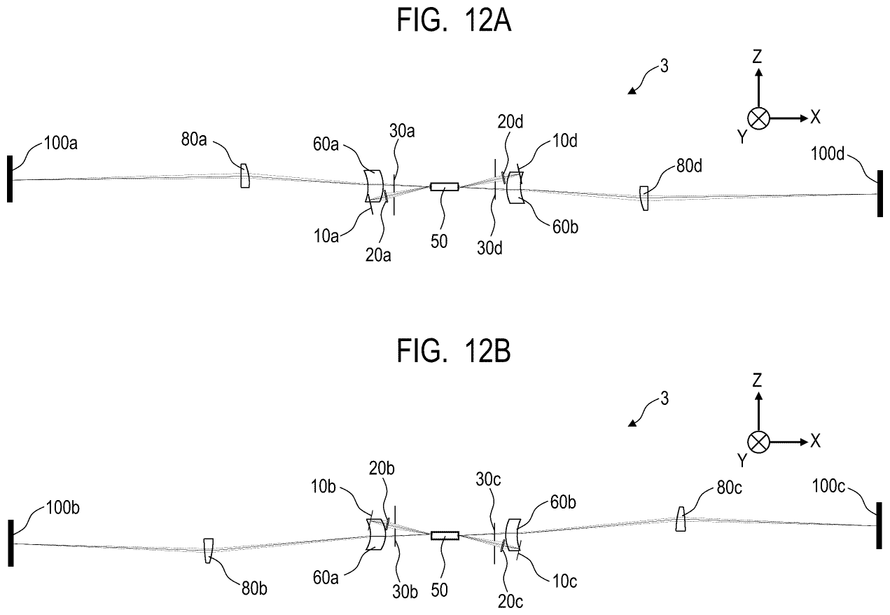

Further, FIG. 12A and FIG. 12B show partial schematic developed views in the sub-scanning cross section of the light scanning apparatus 3 according to the third embodiment.

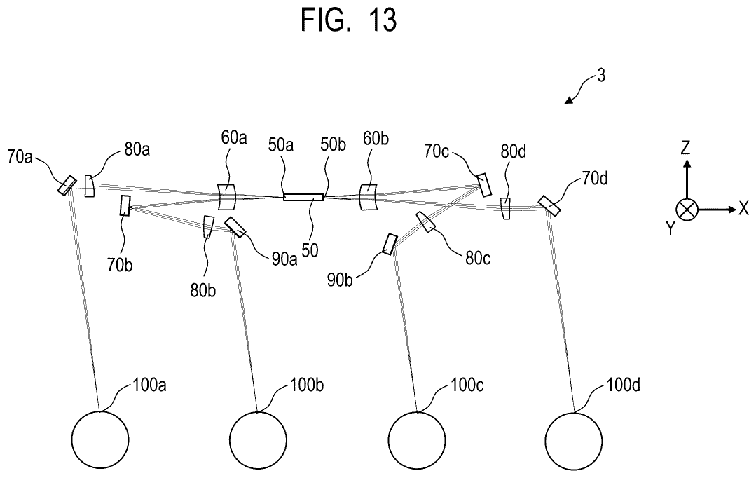

Furthermore, FIG. 13 shows a partial schematic sub-scanning cross sectional view of the light scanning apparatus 3 according to the third embodiment.

Since the light scanning apparatus 3 according to the present embodiment has the same configuration as that of the light scanning apparatus 1 according to the first embodiment except that numerical values are different, the same members are denoted by the same reference numerals, and description thereof is omitted.

Further, Tables 9 and 10 below show specification values, and the refractive index and coordinates of each optical surface in the light scanning apparatus 3 according to the present embodiment.

Furthermore, Tables 11 and 12 below show a shape of each optical surface in the first incident optical system 75a and the first imaging optical system 85a and a shape of each optical surface in the second incident optical system 75b and the second imaging optical system 85b, respectively.

In Table 10, only the first incident optical system 75a and the first imaging optical system 85a, and the second incident optical system 75b and the second imaging optical system 85b are shown.

TABLE 9

| | Parameters | |
|---|---|---|
| | [Units] | Value |
| Wavelength of first to fourth light sources 10a to 10d | λ[nm] | 790 |
| Scan widths of first to fourth scanned surfaces 100a to 100d | W[mm] | 326 |
| Number of deflecting surfaces of deflecting unit 50 | [surfaces] | 4 |
| Circumscribed diameter of deflecting unit 50 | Pd[mm] | 20 |
| Coordinates of rotation center of deflecting unit 50 | (X, Y)[mm] | (6.03, −3.79) |
| Incident angles in main scanning cross section of first to fourth incident | θim[rad] | 1.36 |
| optical systems 75a to 75d | | |
| Incident angles in sub-scanning cross section of first to fourth incident optical | θis[rad] | 0.05 |
| systems 75a to 75d | | |
| Widths in main scanning direction of openings of first to fourth main scanning | Am[mm] | 3.75 |
| stops 40a to 40d | | |
| Widths in sub-scanning direction of openings of first to fourth sub-scanning | As[mm] | 2.70 |
| stops 30a to 30d | | |
| Distances between first to fourth light sources 10a to 10d and first to fourth | Df[mm] | 43.57 |
| diffracting optical elements 20a to 20d | | |
| Distances between first to fourth diffracting optical elements 20a to 20d and | Db[mm] | 115.13 |
| first and second deflecting surfaces 50a and 50b | | |
| Total lengths of first to fourth imaging optical systems 85a to 85d | Tc[mm] | 233 |
| Maximum angles of view of first to fourth imaging optical systems 85a to 85d | θ[rad] | 0.79 |
| Combined magnification of first (fourth) incident optical system 75a (75d) and | βm_out | −5.06 |
| first (fourth) imaging optical system 85a (85d) in main scanning cross section | | |
| Combined magnification of first (fourth) incident optical system 75a (75d) and | βs_out | 3.70 |
| first (fourth) imaging optical system 85a (85d) in sub-scanning cross section | | |
| Combined magnification of second (third) incident optical system 75b (75c) | βm_in | −5.14 |
| and second (third) imaging optical system 85b (85c) in main scanning cross | | |
| section | | |
| Combined magnification of second (third) incident optical system 75b (75c) | βs_in | 3.79 |
| and second (third) imaging optical system 85b (85c) in sub-scanning cross | | |
| section | | |
| Refractive powers of first to fourth diffracting optical elements 20a to 20d in | Prm | 0.0107 |
| main scanning cross section | | |
| Diffractive powers of first to fourth diffracting optical elements 20a to 20d in | Pdm | 0.0125 |
| main scanning cross section | | |
| Refractive powers of first to fourth diffracting optical elements 20a to 20d in | Prs | 0.0166 |
| sub-scanning cross section | | |
| Diffractive powers of first to fourth diffracting optical elements 20a to 20d in | Pds | 0.0150 |
| sub-scanning cross section | | |

TABLE 10

| | Refractive | | | | Direction cosine of | | |
|---|---|---|---|---|---|---|---|
| | index (λ = | Coordinate of surface vertex | | | optical axis | | |
| | 790 nm) | tc(x) | tc(y) | tc(z) | gx(x) | gx(y) | gx(z) |
| Light emitting point of first light source 10a | — | −33.58 | 157.99 | −7.62 | −0.21 | 0.98 | −0.05 |
| Incident surface of first diffracting optical | 1.53 | −24.53 | 115.42 | −5.56 | −0.21 | 0.98 | −0.05 |
| element 20a | | | | | | | |
| Exit surface of first diffracting optical element | — | −23.91 | 112.49 | −5.42 | −0.21 | 0.98 | −0.05 |
| 20a | | | | | | | |
| First sub-scanning stop 30a | — | −19.93 | 93.78 | −4.52 | −0.21 | 0.98 | 0.00 |
| First main scanning stop 40a | — | −14.56 | 68.51 | −3.30 | −0.21 | 0.98 | 0.00 |
| First deflecting surface 50a of deflecting unit 50 | — | 0.53 | 0.66 | 0.00 | −0.78 | 0.63 | 0.00 |
| (when on-axis image height is scanned) | | | | | | | |
| Incident surface of first imaging optical element | 1.53 | −26.00 | 0.00 | 0.00 | −1.00 | 0.00 | 0.00 |
| 60a | | | | | | | |
| Exit surface of first imaging optical element 60a | — | −34.20 | 0.00 | 0.00 | −1.00 | 0.00 | 0.00 |
| Incident surface of second imaging optical | 1.53 | −100.80 | 0.00 | 5.96 | −1.00 | 0.00 | 0.00 |
| element 80a | | | | | | | |
| Exit surface of second imaging optical element | — | −105.10 | 0.00 | 5.96 | −1.00 | 0.00 | 0.00 |
| 80a | | | | | | | |
| Reflecting surface of reflecting optical element | — | −113.67 | 0.00 | 5.58 | −0.76 | 0.00 | 0.65 |
| 70a | | | | | | | |
| First scanned surface 100a | — | −97.70 | 0.00 | −112.69 | — | — | — |
| Light emitting point of first light source 10b | — | −33.58 | 157.99 | 7.62 | −0.21 | 0.98 | 0.05 |
| Incident surface of second diffracting optical | 1.53 | −24.53 | 115.42 | 5.56 | −0.21 | 0.98 | 0.05 |
| element 20b | | | | | | | |
| Exit surface of second diffracting optical | — | −23.91 | 112.49 | 5.42 | −0.21 | 0.98 | 0.05 |
| element 20b | | | | | | | |
| Second sub-scanning stop 30b | — | −19.93 | 93.78 | 4.52 | −0.21 | 0.98 | 0.00 |
| Second main scanning stop 40b | — | −14.56 | 68.51 | 3.30 | −0.21 | 0.98 | 0.00 |
| First deflecting surface 50a of deflecting unit 50 | — | 0.53 | 0.66 | 0.00 | −0.78 | 0.63 | 0.00 |
| (when on-axis image height is scanned) | | | | | | | |
| Incident surface of first imaging optical element | 1.53 | −26.00 | 0.00 | 0.00 | −1.00 | 0.00 | 0.00 |
| 60a | | | | | | | |
| Exit surface of first imaging optical element 60a | — | −34.20 | 0.00 | 0.00 | −1.00 | 0.00 | 0.00 |
| Incident surface of second imaging optical | 1.53 | −42.87 | 0.00 | −15.46 | −0.99 | 0.00 | 0.16 |
| element 80b | | | | | | | |
| Exit surface of second imaging optical element | — | −38.63 | 0.00 | −16.15 | −0.99 | 0.00 | 0.16 |
| 80b | | | | | | | |
| Reflecting surface of reflecting optical element | — | −81.82 | 0.00 | −4.68 | −1.00 | 0.00 | 0.08 |
| 70b | | | | | | | |
| Reflecting surface of reflecting optical element | — | −28.10 | −4.50 | −17.47 | −0.70 | 0.00 | −0.71 |
| 90a | | | | | | | |
| Second scanned surface 100b | — | −14.70 | 0.00 | −112.69 | — | — | — |

TABLE 11

| | Aspherical surface coefficient | | | | | | |
|---|---|---|---|---|---|---|---|
| | | | | Upper optical portion | | | |
| | | First diffracting optical | | 60au of first imaging | | Second imaging optical | |
| | | element 20a | | optical element 60a | | element 80a | |
| | | Incident | Exit | Incident | Exit | Incident | Exit |
| | Coefficient | surface | surface | surface | surface | surface | surface |
| Meridional | R | — | −4.94E+01 | −7.20E+01 | −4.32E+01 | 4.00E+03 | 3.46E+02 |
| line | K | — | — | 8.92E−01 | −5.73E−01 | — | −9.02E+01 |
| | B3 | — | — | — | — | — | — |
| | B4 | — | — | −7.61E−07 | −1.99E−07 | — | −2.17E−07 |
| | B5 | — | — | — | — | — | — |
| | B6 | — | — | 6.79E−09 | 1.64E−09 | — | 1.80E−11 |
| | B7 | — | — | — | — | — | — |
| | B8 | — | — | −5.89E−12 | 1.27E−12 | — | −1.07E−15 |
| | B9 | — | — | — | — | — | — |
| | B10 | — | — | 1.62E−15 | −1.42E−15 | — | 2.98E−20 |
| Sagittal | r | — | −3.17E+01 | 2.00E+01 | 2.06E+01 | 2.69E+01 | 2.67E+02 |
| line | E1 | — | — | — | — | — | 1.97E−07 |
| | E2 | — | — | — | 1.56E−05 | −5.14E−06 | −2.37E−06 |
| | E3 | — | — | — | — | — | −3.44E−09 |
| | E4 | — | — | — | −3.39E−08 | — | −2.47E−10 |
| | E5 | — | — | — | — | — | 1.50E−12 |
| | E6 | — | — | — | 3.96E−11 | — | 1.69E−14 |
| | E7 | — | — | — | — | — | −2.50E−16 |
| | E8 | — | — | — | −6.56E−14 | — | −1.80E−18 |
| | E9 | — | — | — | — | — | 1.41E−20 |
| | E10 | — | — | — | 5.40E−17 | | 7.12E−23 |
| | m0_1 | — | — | — | −3.93E−02 | −1.51E−01 | 1.07E−02 |
| | m1_1 | — | — | — | — | −5.64E−06 | 2.98E−06 |
| | m2_1 | — | — | — | 3.68E−05 | −2.60E−05 | −4.00E−05 |
| | m3_1 | — | — | — | — | 1.31E−07 | 1.17E−07 |
| | m4_1 | — | — | — | — | 5.69E−09 | 7.91E−09 |
| | m5_1 | — | — | — | — | −3.83E−11 | −3.15E−11 |
| | m6_1 | — | — | — | — | 8.34E−14 | −6.67E−13 |
| | m7_1 | — | — | — | — | 5.13E−15 | 3.85E−15 |
| | m8_1 | — | — | — | — | −2.89E−17 | 8.31E−17 |
| | m9_1 | — | — | — | — | −2.20E−19 | −1.37E−19 |
| | m10_1 | — | — | — | — | −5.52E−22 | −5.82E−21 |
| | C3(Z²) | −7.51E−03 | — | — | — | — | — |
| | C5(Y²) | −6.27E−03 | — | — | — | — | — |

TABLE 12

| | Aspherical surface coefficient | | | | | | |
|---|---|---|---|---|---|---|---|
| | | | | Lower optical portion | | | |
| | | Second incident optical | | 60al of first imaging | | Second imaging optical | |
| | | element 20b | | optical element 60a | | element 80b | |
| | | Incident | Exit | Incident | Exit | Incident | Exit |
| | Coefficient | surface | surface | surface | surface | surface | surface |
| Meridional | R | — | −4.94E+01 | −7.20E+01 | −4.43E+01 | 4.00E+03 | −3.84E+02 |
| line | K | — | — | 8.92E−01 | −1.16E+00 | — | −7.63E+01 |
| | B3 | — | — | — | — | — | — |
| | B4 | — | — | −7.61E−07 | −1.52E−06 | — | 1.34E−07 |
| | B5 | — | — | — | — | — | — |
| | B6 | — | — | 6.79E−09 | 1.75E−09 | — | −7.45E−12 |
| | B7 | — | — | — | — | — | — |
| | B8 | — | — | −5.89E−12 | 9.64E−13 | — | 3.30E−16 |
| | B9 | — | — | — | — | — | — |
| | B10 | — | — | 1.62E−15 | −1.20E−15 | — | −7.02E−21 |
| Sagittal | r | — | −3.17E+01 | 2.00E+01 | 5.46E+01 | −4.62E+01 | 1.17E+02 |
| line | E1 | — | — | — | — | — | 7.53E−07 |
| | E2 | — | — | — | 3.97E−06 | −5.27E−09 | −1.79E−06 |
| | E3 | — | — | — | — | — | 7.48E−10 |
| | E4 | — | — | — | 9.86E−08 | — | 2.81E−10 |
| | E5 | — | — | — | — | — | −1.82E−13 |
| | E6 | — | — | — | −2.89E−10 | — | −4.07E−14 |
| | E7 | — | — | — | — | — | 1.74E−17 |
| | E8 | — | — | — | 3.62E−13 | — | 3.25E−18 |
| | E9 | — | — | — | — | — | −5.09E−22 |
| | E10 | — | — | — | −1.62E−16 | — | −9.98E−23 |
| | m0_1 | — | — | — | 1.14E−01 | −1.50E−01 | 7.95E−02 |
| | m1_1 | — | — | — | — | −2.04E−05 | −1.32E−05 |
| | m2_1 | — | — | — | −5.07E−05 | −3.51E−08 | −1.55E−05 |
| | m3_1 | — | — | — | — | 4.84E−08 | 4.46E−08 |
| | m4_1 | — | — | — | — | −5.23E−10 | 1.81E−09 |
| | m5_1 | — | — | — | — | −1.02E−11 | −8.81E−12 |
| | m6_1 | — | — | — | — | 2.07E−13 | −1.66E−13 |
| | m7_1 | — | — | — | — | 9.45E−16 | 7.76E−16 |
| | m8_1 | — | — | — | — | −2.87E−18 | 2.43E−17 |
| | m9_1 | — | — | — | — | −2.86E−20 | −2.11E−20 |
| | m10_1 | — | — | — | — | 7.60E−23 | −4.80E−22 |
| | C3(Z²) | −7.51E−03 | — | — | — | — | — |
| | C5(Y²) | −6.27E−03 | — | — | — | — | — |

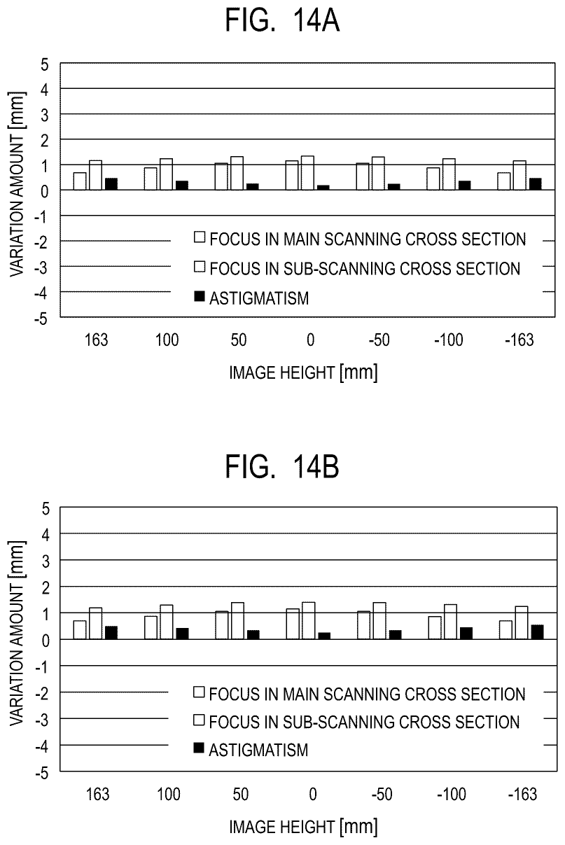

FIG. 14A shows an image height dependence of variation amounts in the focus in the main scanning cross section, in the focus in the sub-scanning cross section and in astigmatism on the first scanned surface 100a when the temperature increases by 25° C. in the light scanning apparatus 3 according to the present embodiment.

Further, FIG. 14B shows an image height dependence of variation amounts in the focus in the main scanning cross section, in the focus in the sub-scanning cross section and in astigmatism on the second scanned surface 100b when the temperature increases by 25° C. in the light scanning apparatus 3 according to the present embodiment.

As shown in FIG. 14A and FIG. 14B, in each of the first and second scanned surfaces 100a and 100b when the temperature increases by 25° C., the variation amount in the focus in the main scanning cross section and that in the sub-scanning cross section are comparable with each other.

When the temperature increases by 25° C., the variation amount in astigmatism is less than or equal to 1 mm over the entire image heights on each of the first and second scanned surfaces 100a and 100b, so that the increase in astigmatism can be effectively suppressed.

In the light scanning apparatus 3 according to the present embodiment, since D_{f}/D_{b}=43.57/115.13=0.378 is obtained in the first to fourth incident optical systems 75a to 75d from Table 9, the inequality (5) is satisfied.

In the light scanning apparatus 3 according to the present embodiment, since |P_{dm}|/|Pᵣₘ|=0.0125/0.0107=1.168 is obtained in the first to fourth optical elements 20a to 20d from Table 9, the inequalities (6), (6a) and (6b) are satisfied.

In the light scanning apparatus 3 according to the present embodiment, |βₘ|/|βₛ|=|−5.06|/|3.70|=1.368 is obtained for the first and fourth scanned surfaces 100a and 100d from Table 9.

For the second and third scanned surfaces 100b and 100c, |βₘ|/|βₛ|=|−5.14|/|3.79|=1.356 is obtained.

Therefore, in the light scanning apparatus 3 according to the present embodiment, the inequalities (7) and (7a) are satisfied for the first to fourth scanned surfaces 100a to 100d.

Further, in the light scanning apparatus 3 according to the present embodiment, since |P_{ds}|/|Pᵣₛ|=|0.0150|/|0.0166|=0.903 is obtained in the first to fourth optical elements 20a to 20d from Table 9, the inequalities (8), (8a) and (8b) are satisfied.

In the light scanning apparatus 3 according to the present embodiment, since T_{c}×tan θ=233×tan (0.79)=235.154 is obtained in the first to fourth imaging optical systems 85a to 85d from Table 9, the inequalities (9) and (9a) are satisfied.

As described above, in the light scanning apparatus 3 according to the present embodiment, the first to fourth incident optical systems 75a to 75d that guide the first to fourth light fluxes from the first to fourth light sources 10a to 10d to the deflecting unit 50 consist of the first to fourth optical elements 20a to 20d having the diffracting surfaces, respectively.

When the inequalities (5) and (6) are satisfied in such incident optical systems, it is possible to sufficiently suppress an increase in astigmatism due to an increase in temperature in the light scanning apparatus 3 according to the present embodiment.

Table 13 below shows values of the inequalities in each of the light scanning apparatuses according to the first to third embodiments.

TABLE 13

| | First | Second | Third |
|---|---|---|---|
| Conditional expression | embodiment | embodiment | embodiment |
| (5): 0.20 ≤ Df/Db ≤ 0.40 | 0.268 | 0.268 | 0.378 |
| (6): 1.00 < \|Pdm\|/\|Prm\| ≤ 1.50 | 1.106 | 1.062 | 1.168 |
| (6a): 1.00 < \|Pdm\|/\|Prm\| ≤ 1.30 | | | |
| (6b): 1.00 < \|Pdm\|/\|Prm\| ≤ 1.20 | | | |
| (7): 1.00 < \|βm\|/\|βs\| | 1.236 (First | 1.217 (First | 1.368 (First |
| (7a): 1.00 < \|βm\|/\|βs\| ≤ 1.40 | and Fourth) | and Fourth) | and Fourth) |
| (7b): 1.10 ≤ \|βm\|/\|βs\| ≤ 1.30 | 1.257 (Second | 1.238 (Second | 1.356 (Second |
| | and Third) | and Third) | and Third) |
| (8): \|Pds\|/\|Prs\| < 1.00 | 0.856 | 0.856 | 0.903 |
| (8a): 0.80 ≤ \|Pds\|/\|Prs\| < 1.00 | | | |
| (8b): 0.80 ≤ \|Pds\|/\|Prs\| ≤ 0.95 | | | |
| (9): 200 ≤ Tc × tanθ ≤ 300 | 235.154 | 235.154 | 235.154 |
| (9a): 200 ≤ Tc × tanθ ≤ 250 | | | |

According to the present embodiments, a light scanning apparatus capable of sufficiently suppressing an increase in astigmatism due to an increase in temperature can be provided.

### [Image Forming Apparatus]

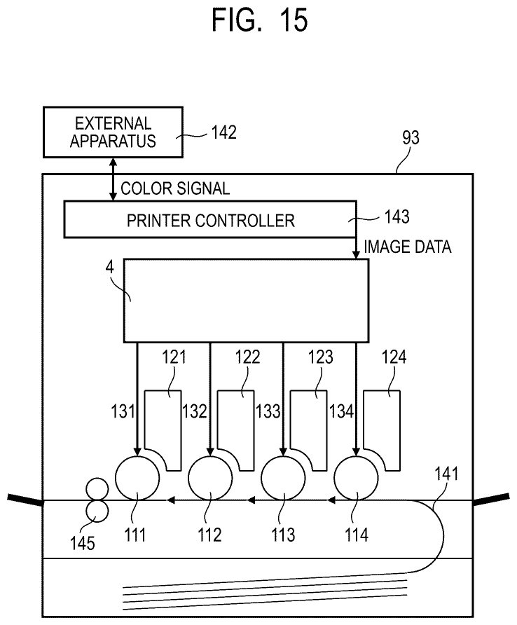

FIG. 15 shows a sub-scanning cross sectional view of a main part of an image forming apparatus 93 including a light scanning apparatus 4 according to any one of the first to third embodiments of the present invention.

The image forming apparatus 93 is a 4 in 1 type color image forming apparatus that records image information on photosensitive surfaces of four photosensitive drums as image bearing bodies by using the single light scanning apparatus 4 according to any one of the first to third embodiments.

Specifically, the image forming apparatus 93 includes the light scanning apparatus 4 according to any one of the first to third embodiments, photosensitive drums 111, 112, 113 and 114, developing units 121, 122, 123 and 124, and a conveying belt 141.

Further, the image forming apparatus 93 includes a printer controller 143 and a fixing unit 145.

As shown in FIG. 15, color signals of R (red), G (green) and B (blue) output from an external apparatus 142 such as a personal computer are input to the image forming apparatus 93.

The input color signals are converted into image data (dot data) of C (cyan), M (magenta), Y (yellow) and B (black) by the printer controller 143 provided in the image forming apparatus 93.

Next, the converted image data is input to the light scanning apparatus 4. Light fluxes 131, 132, 133 and 134 modulated in accordance with the image data are emitted from the light scanning apparatus 4, and the photosensitive surfaces of the photosensitive drums 111, 112, 113 and 114 are scanned in the main scanning direction by the emitted light fluxes 131 to 134, respectively.

Further, charging rollers (not shown) for uniformly charging the surfaces of the photosensitive drums 111 to 114 are provided so as to abut on the surfaces.

The surfaces of the photosensitive drums 111 to 114 charged by the charging rollers are irradiated with the light fluxes 131 to 134 from the light scanning apparatus 4.

As described above, the light fluxes 131 to 134 are modulated on the basis of the image data of the respective colors, and electrostatic latent images are formed on the surfaces of the photosensitive drums 111 to 114 by the irradiation with the light fluxes 131 to 134.

The formed electrostatic latent images are developed as toner images by the developing units 121, 122, 123 and 124 arranged so as to abut on the photosensitive drums 111 to 114.

The toner images developed by the developing units 121 to 124 are multi-transferred onto a sheet (transferred material) (not shown) conveyed on the conveying belt 141 by transferring rollers (transferring unit) (not shown) arranged to face the photosensitive drums 111 to 114. Thereby, one full-color image is formed.

The sheet to which the unfixed toner image has been transferred as described above is further conveyed to a fixing unit 145 provided at a downstream side of the photosensitive drums 111 to 114 (on the left side in FIG. 15).

The fixing unit 145 is formed by a fixing roller having a fixing heater (not shown) therein and a pressurizing roller arranged so as to come into pressure contact with the fixing roller.

Then, the sheet conveyed from the transferring portion is heated with being pressed by a pressure contact portion between the fixing roller and the pressurizing roller, thereby the unfixed toner image on the sheet is fixed.

Further, a sheet discharging roller (not shown) is arranged at a downstream side of the fixing roller, and the sheet discharging roller discharges the sheet on which the toner image is fixed to the outside of the image forming apparatus 93.

In the image forming apparatus 93, the light scanning apparatus 4 can record an image signal (image information) on the photosensitive surfaces of the photosensitive drums 111 to 114 corresponding to the respective colors of C (cyan), M (magenta), Y (yellow) and B (black) to print a color image at high speed.

As the external apparatus 142, for example, a color image reading apparatus including a CCD sensor may be used.

In this case, the color image reading apparatus and the image forming apparatus 93 form a color digital copying machine.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070396, filed Apr. 24, 2024, which is hereby incorporated by reference herein in its entirety.

What is claimed is:

1. A light scanning apparatus comprising:
a deflecting unit configured to deflect a first light flux from a first light source to scan a first scanned surface in a main scanning direction; and
a first incident optical system which includes a first optical portion having a diffracting surface, and is configured to guide the first light flux from the first light source to a first deflecting surface of the deflecting unit,
wherein a following condition is satisfied:
$$1. < \vert {P}_{d m} \vert / \vert {P}_{rm} \vert \leq 1.5$$
where Pᵣₘ and P_{dm} represent a refractive power and a diffractive power in a main scanning cross section of the first optical portion, respectively.

2. The light scanning apparatus according to claim 1, wherein a following condition is satisfied:
$$0.2 \leq {D}_{f} / {D}_{b} \leq 0.4$$
where D_{f} and D_{b} represent a distance between a light emitting surface of the first light source and an incident surface of the first optical portion, and a distance between an exit surface of the first optical portion and an on-axis deflection point on the first deflecting surface on an optical axis of the first incident optical system, respectively.

3. The light scanning apparatus according to claim 1, wherein at least one of an incident surface and an exit surface of the first optical portion is the diffracting surface.

4. The light scanning apparatus according to claim 1, further comprising a first optical system configured to guide the first light flux deflected by the first deflecting surface to the first scanned surface.

5. The light scanning apparatus according to claim 4, wherein an absolute value of a combined magnification of the first incident optical system and the first optical system in the main scanning cross section is larger than an absolute value of a combined magnification of the first incident optical system and the first optical system in a sub-scanning cross section.

6. The light scanning apparatus according to claim 1, wherein, in a sub-scanning cross section, an absolute value of a refractive power of the first optical portion is larger than an absolute value of a diffractive power of the first optical portion.

7. The light scanning apparatus according to claim 4, wherein a following condition is satisfied:
$$200 \leq {T}_{c} \times tan θ \leq 300$$
where T_{c} represents a distance between an on-axis deflection point on the first deflecting surface and the first scanned surface on an optical axis of the first optical system, and θ represents an angle between the optical axis of the first optical system and a traveling direction of the first light flux traveling toward an outermost off-axis image height of the first scanned surface immediately after deflected by the first deflecting surface in the main scanning cross section.

8. The light scanning apparatus according to claim 1, further comprising the first light source including a plurality of light emitting points.

9. The light scanning apparatus according to claim 1, comprising:
a second incident optical system which includes a second optical portion having a diffracting surface, and is configured to guide a second light flux from a second light source to the first deflecting surface; and
a second optical system configured to guide the second light flux deflected by the first deflecting surface to a second scanned surface,
wherein the deflecting unit is configured to deflect the second light flux from the second light source to scan the second scanned surface in the main scanning direction.

10. The light scanning apparatus according to claim 9, wherein at least one of an incident surface and an exit surface of the second optical portion is the diffracting surface

11. The light scanning apparatus according to claim 9, wherein the first and second optical portions are provided in a single optical element.

12. The light scanning apparatus according to claim 9, comprising:
third and fourth incident optical systems configured to guide third and fourth light fluxes from third and fourth light sources to a second deflecting surface of the deflecting unit, respectively; and
third and fourth optical systems configured to guide the third and fourth light fluxes deflected by the second deflecting surface to third and fourth scanned surfaces, respectively,
wherein the deflecting unit is configured to deflect the third and fourth light fluxes from the third and fourth light sources to scan the third and fourth scanned surfaces in the main scanning direction, respectively,
wherein the third incident optical system includes a third optical portion having a diffracting surface, and
wherein the fourth incident optical system includes a fourth optical portion having a diffracting surface.

13. The light scanning apparatus according to claim 12,
wherein at least one of an incident surface and an exit surface of the third optical portion is the diffracting surface, and
wherein at least one of an incident surface and an exit surface of the fourth optical portion is the diffracting surface.

14. The light scanning apparatus according to claim 12, wherein the third and fourth optical portions are provided in a single optical element.

15. The light scanning apparatus according to claim 1, wherein the first optical portion is configured to convert the first light flux from the first light source into a parallel light flux in the main scanning cross section, and to condense the first light flux from the first light source in a sub-scanning cross section.

16. The light scanning apparatus according to claim 1, wherein the first incident optical system is configured to cause the first light flux from the first light source to be obliquely incident on the first deflecting surface in a sub-scanning cross section.

17. The light scanning apparatus according to claim 4, a following condition is satisfied:
$$1. < \vert {β}_{m} \vert / \vert {β}_{s} \vert \leq 1.4$$
where βₘ and βₛ represent combined magnifications of the first incident optical system and the first optical system in the main scanning cross section and a sub-scanning cross section, respectively.

18. The light scanning apparatus according to claim 1, a following condition is satisfied:
$$0.8 \leq \vert {P}_{d s} \vert / \vert {P}_{rs} \vert < 1.$$
where Pᵣₛ and P_{ds} represent a refractive power and a diffractive power in a sub-scanning cross section of the first optical portion, respectively.

19. An image forming apparatus comprising:
the light scanning apparatus according to claim 1; and
a developing unit configured to develop an electrostatic latent image formed on the first scanned surface by the light scanning apparatus.

20. An image forming apparatus comprising:
the light scanning apparatus according to claim 1; and
a controller configured to convert a signal output from an external apparatus into image data and input the image data to the light scanning apparatus.
